(19) United States
(12) Patent Application Publication
(10) Pub. No.: US 2025/0068395 A1
(43) Pub. Date: Feb. 27, 2025

(54) Inner Products with Secure Multi-Party Computations

(71) Applicant: SEDICII INNOVATIONS LTD., Waterford (IE)

(72) Inventor: Miguel DE VEGA RODRIGO, Santa Cruz de Tenerife (ES)

(73) Assignee: SEDICII INNOVATIONS LTD., Waterford (IE)

(21) Appl. No.: 18/724,513

(22) PCT Filed: Feb. 28, 2023
(86) PCT No.: PCT/EP2023/054939

§ 371 Date: Jun. 26, 2024

(30) Foreign Application Priority Data
Feb. 28, 2022 (EP) 22159312.2

(51) Int. Cl. G06F 7/58

(52) U.S. Cl. CPC G06F 7/582

(57) ABSTRACT

A secure multiparty computation method permits the computation of an inner product of a pair of secret vectors. The vectors are transformed and blinded using various blinding factors with the transforms of the vectors being according to a discrete linear transform for which Parseval's theorem holds. Shares of the transformed, blinded vectors are distributed to computing nodes which each calculate shares of a result without access to the secrets, and the result shares can be combined to generate the inner product of the original vectors.

### TECHNICAL FIELD

This invention relates to improvements in computing inner products between multidimensional vectors using Secure Multi Party Computation (SMPC).

### BACKGROUND ART

Secure Multi Party Computation (SMPC) enables a set of parties to collaboratively compute a function over their inputs while keeping them private. There are several SMPC flavours described in the literature, including Yao's Garbled Circuits (Yao, Andrew Chi-Chih (1986). “How to generate and exchange secrets”. 27th Annual Symposium on Foundations of Computer Science (SFCS 1986). Foundations of Computer Science, 1986, 27th Annual Symposium on. pp. 162-167. doi:10.1109/SFCS.1986.25. ISBN 978-0-8186-0740-0), GMW (O. Goldreich, S. Micali, A. Wigderson, “How to play ANY mental game”, Proceedings of the nineteenth annual ACM symposium on Theory of Computing, January 1987, Pages 218-229, doi:10.1145/28395.28420; and T. Schneider and M. Zohner, “GMW vs. Yao? Efficient secure two-party computation with low depth circuits,” in Financial Cryptography and Data Security (FC '13), ser. LNCS, vol. 7859. Springer, 2013, pp. 275-292), BGW (Ben-Or, M., Goldwasser, S., Wigderson, A.: Completeness theorems for Non-Cryptographic Fault-Tolerant Distributed Computation. In: Proc. ACM STOC '88, pp. 1-10 (1988)), SPDZ (Damgård I., Pastro V., Smart N., Zakarias S. (2012) Multiparty Computation from Somewhat Homomorphic Encryption. In: Safavi-Naini R., Canetti R. (eds) Advances in Cryptology—CRYPTO 2012. CRYPTO 2012. Lecture Notes in Computer Science, vol 7417. Springer, Berlin, Heidelberg. https://doi.org/10.1007/978-3-642-32009-5_38), BMR (Beaver, D., S. Micali, and P. Rogaway. 1990. “The Round Complexity of Secure Protocols (Extended Abstract)”. In: 22nd Annual ACM Symposium on Theory of Computing. ACM Press. 503-513), and GESS (Kolesnikov, V. 2005. “Gate Evaluation Secret Sharing and Secure One-Round Two-Party Computation”. In: Advances in Cryptology—ASIACRYPT 2005. Ed. by B. K. Roy. Vol. 3788. Lecture Notes in Computer Science. Springer, Heidelberg. 136-155).

There are two main constructions of SMPC: Circuit Garbling (CG) and Linear Secret Sharing (LSS). Circuit garbling requires encrypting keys in a specific order to simulate the function evaluation. Linear Secret Sharing computes shares from the inputs and distributes them among the nodes. In this disclosure we focus on SMPC flavours using LSS.

The following is a list of the main roles for the nodes participating in a SMPC computation:
Dealer node: These nodes contribute inputs to the computation
Computing node: These nodes perform the actual SMPC computation on the inputs provided by dealer nodes
Result node: These nodes reconstruct the result from a finished SMPC computation

A node can have more than one role. For example, a node can be dealer, computing and result node at the same time.

FIG. 1 is a network diagram showing a plurality of nodes that co-operate to perform a secure multiparty computation (SMPC). The nodes are categorised as dealer nodes 10, computing nodes 12, and result nodes 14.

Not all of the nodes are labelled with a reference numeral but it should be understood that all nodes in the same group are of the same type i.e. all nodes in the left vertical line are dealer nodes 10, all nodes in the central octagonal group are computing nodes, and all nodes in the right vertical line are result nodes.

It should also be understood by the skilled person that both in the conventional arrangement of FIG. 1 and in the present invention, the arrangement and number of nodes is not intended to represent any specific reality, and nodes are likely to be arranged into logical rather than physical groups, with nodes able to communicate with any other node via a network address on a public or private network which could be a local area network, or a wide area network. Nodes could be even part of the same computing system e.g. different processors or cores in a multiprocessor system. Communication protocols are at the choice of the system designer and are likely to be dictated by the application and security requirements of the system in which they are implemented.

Each node may be implemented in a processor of a computing system which is programmed to perform the relevant methods and algorithms disclosed herein, and further has access to a memory, and a network connection. In many implementations, each node will be a suitably programmed computer system.

The dealer nodes 10 contribute inputs to the computation. Specifically, they are provided with secret inputs, and create shares from these secret inputs and distribute them among the computing nodes 12. The computing nodes perform the actual SMPC computation and each computing node 12 provides a share of a computation output to each result node 14. The result nodes 14 reconstruct the result from the received result shares.

LSS SMPC protocols comprise the following three phases:

Phase 1—Share distribution: Each dealer node breaks down each private input to the computation into a number N of shares and sends each share to a different computing node. Each share reveals no information about the private input. It is only when all N shares from a private input are gathered that it can be reconstructed.

Phase 2—Computation: Each computing node has one share from each private input to a computation. The computation consists of evaluating the output of a function over the private inputs. In order to do this, the computing nodes perform operations on their shares that depend on the specific function to be evaluated by the SMPC protocol.

Phase 3—Result reconstruction: After Phase 2, each computing node has obtained a share from the result of the computation (i.e. the function to be evaluated). They send their share to one or several result nodes. After gathering all N shares from the result, a result node can reconstruct the output of the function that was jointly evaluated.

For example, assume that two dealer nodes have each one string. They would like the network of computing nodes to evaluate the result from comparing the two strings and to communicate this result to a result node. The strings are private to the dealer nodes, so they should not be sent over to the computing nodes in plaintext or in encrypted form. Each dealer node breaks down their private string into N shares and send each share to a different computing node. After receiving one share per each one of the two strings to be compared, the computing nodes follow the SMPC protocol to obtain a share of the result from the computation. This result could be a Boolean representing a string match with a TRUE value and a string mismatch with a FALSE value. Each node sends their share of the result to a result node, which reconstructs the TRUE or FALSE result from the string comparison.

The main problem with SMPC is the communication complexity. A large number of message exchanges and/or communication bandwidth is required in order for the computing nodes to collaboratively obtain in Phase 2 a share of the result of the function being evaluated when this function is nontrivial. By nontrivial we mean a function with a large number of inputs and a large number of operations on those inputs. Real-world applications of SMPC typically require nontrivial functions, which severely affects the applicability of SMPC in production scenarios.

For example, in GMW SMPC computing nodes are able to evaluate Boolean functions on binary inputs. A Boolean function is a function comprising AND, OR, XOR, NAND, NOR and NXOR logical gates. Using simple algebraic equivalences, it is possible to transform any Boolean function into its Arithmetic Normal Form (ANF). This form comprises groups of AND gates linked by XOR gates. Computing nodes running GMW can process XOR gates without the need to exchange any message, hence with great efficiency. However, the evaluation of each AND gate requires the exchange of messages. Nontrivial functions will have XOR as well as AND gates, making the overall GMW function evaluation slow

In another example, let us evaluate BGW SMPC. In this SMPC flavour computing nodes evaluate arithmetic functions on integer inputs comprising additions and multiplications. Computing nodes running BGW can process additions without the need to exchange any message. However, the evaluation of multiplications requires the exchange of messages. Once more, nontrivial functions will have additions and multiplications, making the overall BGW function evaluation slow.

As a notable exception to the SMPC scalability problem mentioned above we have FMPC (Sonnino, Alberto. “FMPC: Secure Multiparty Computation from Fourier Series and Parseval's Identity.” arXiv preprint arXiv:1912.02583 (2019)), an SMPC protocol for arithmetic circuits based on Fourier series capable of evaluating the multiplication of secrets with no online communication. FMPC makes use of Parseval's Theorem to allow for the multiplication of secrets without requiring the nodes to exchange any message. However, there are significant drawbacks with this approach:
FMPC is limited to two computing nodes only. Real-world SMPC applications may require multiple computing nodes. If nodes 1 and 2 collude in FMPC, the secret inputs will be revealed. For real world applications, it is generally preferred to allow for a larger number M computing nodes, and to require the collusion of all M nodes in order to leak the secrets. This allows turning M into an important security parameter: The higher M, the more safe the network is against collusion attacks.
In FMPC each share comprises parametric equations (sometimes more than one) that describe the infinite sequence of Fourier coefficients, and not discrete values. All of the parameters of the parametric mask functions must be sent to the nodes, consuming more bandwidth. To this, it must be added the fact that the functions are complex-valued, which opens up the problem of digitally representing real numbers with enough precision so that the function can be reconstructed by the dealer node without errors.
FMPC presents a compromise between security and computational efficiency. On the one hand, it requires the computation of scalar products of vectors with infinite components, which introduces problems around computational efficiency and correctness. These problems are addressed with a convenient choice of the mask functions, that allow evaluating the scalar products of vectors with infinite components analytically. However, on the other hand, limiting the choice of the mask functions to those amenable to analytic calculations makes it easier for an attacker to guess them. This negatively impacts the security of the protocol, since it requires that the mask functions remain private to a trusted authority.
FMPC focuses on the multiplication of secrets, and assumes that additions can be performed using traditional algebra as described by SPDZ.
FMPC assumes the presence of a trusted authority to do a trusted setup. This significantly limits the range of applications to which it is suited.

The present invention aims to overcome these limitations, and specifically to do so in the context of the evaluation with SMPC of a particular type of function involving the computation of an inner product between two multidimensional vectors. The evaluation of the inner product function using SMPC is the focus of this invention because it supports the evaluation of any generic function with private inputs from one or two dealers.

In the arithmetic setting this can be seen by noticing that:
1) A generic function over a set of secret inputs S={s₀, s₁, . . . , s_{S-1}} can be expressed as sums of products over the inputs:

$$f = f ( {s}_{0} , {s}_{1} , … , {s}_{S - 1} ) = {\sum }_{a = 0}^{N - 1} {\prod }_{m = 0}^{{M}_{a} - 1} {s}_{{i}_{a , m}} mod p$$

2) If the inputs are all coming from two dealers, then each dealer can locally multiply their secrets in the a-th sum to obtain xₐ and yₐ, respectively, such that the set S can be expressed as S={x₀, x₁, . . . , x_{N-1}, y₀, y₁, . . . , y_{N-1}} and the equation above simplifies to an inner product:

$$f = f ( {x}_{0} , {x}_{1} , … , {x}_{N - 1} , {y}_{0} , {y}_{1} , … , {y}_{N - 1} ) = ( {\sum }_{a = 0}^{N - 1} {x}_{a} \cdot {y}_{a} ) mod p$$

More formally, let x=(x₀, x₁, . . . , x_{N-1}) and y=(y₀, y₁, . . . , y_{N-1}) be two vectors with N dimensions, each known to a different dealer. The inner product, scalar product or dot product of these two vectors, represented as <x,y> is defined as:

$$〈 x , y 〉 = {\sum }_{i = 0}^{N - 1} {x}_{i} \cdot {y}_{i} \qquad Eq . 1$$

In particular, the evaluation of the inner product allows for the computation of a series of core functions which in turn underpin important use cases. In the arithmetic setting, some examples of such core functions are:
The Euclidean distance between the two vectors in Euclidean space, which is the length of the line segment between the two vectors. The Euclidean distance can be computed using an inner product.
The covariance between two random variables X and Y is a measure of their joint variability. A positive covariance indicates that they tend to move in the same direction, whereas a negative covariance reveals that the two variables tend to move in inverse directions. The covariance can be estimated from observations of both random variables using the sample covariance, which can be expressed as an inner product.
The correlation between two random variables X and Y refers to the degree to which a pair of variables are linearly related. It can be expressed in terms of three covariance calculations between X and Y, X and X, and Y and Y, which in turn can be computed as inner products.
The Euclidean norm of a vector determines its size. In a Euclidean vector space, it can be computed as an inner product.
The cosine similarity between two vectors is equal to the cosine of the angle between them, which in turn measures how similar these vectors are. The cosine similarity can be expressed in terms of 3 inner products, two of which represent the norms of each one of the vectors.

The computation of these functions finds numerous applications in disciplines such as physics, chemistry, mathematics, biology, and psychology, in industries such as finance, health, aeronautic, telecommunications, and insurance, and to tackle problems such as global warming, money laundering, and epidemics.

### DISCLOSURE OF THE INVENTION

In a first aspect there is provided a computer-implemented method of performing a multi-party computation by a network of data processors, said data processors comprising first and second dealer nodes, a plurality of M computing nodes, and at least one result node, the method comprising:
(a) providing the first dealer node with a random vector A having components (A₀, A₁, . . . , A_{M-1}) all of which are non-zero;
(b) providing the second dealer node with an inverse vector A⁻¹ having components (A₀⁻¹, A₁⁻¹, . . . , A_{M-1}⁻¹), such that for each i∈{0, . . . , M−1}, the product Aᵢ·Aᵢ⁻¹=1;
(c) the first dealer node computing a first transformed vector X=(X₀, X₁, . . . , X_{M-1}) of a first private input vector x=(x₀, x₁, . . . , x_{M-1}), according to a discrete linear transform for which Parseval's theorem holds;
(d) the first dealer node computing a first blinded vector U=(U₀, U₁, . . . , U_{M-1}) as U=A∘X where the operator ∘ represents the Hadamard product;
(e) the second dealer node computing a second transformed vector Y=(Y₀, Y₁, . . . , Y_{M-1}) of a second private input vector y=(y₀, y₁, . . . , y_{M-1}), according to said discrete linear transform;
(f) the second dealer node computing a second blinded vector V=(V₀, V₁, . . . , V_{M-1}) as V=A⁻¹∘Y where the operator ∘ represents the Hadamard product;
(g) the first dealer sending the i-th component Uᵢ of the first blinded vector U to the i-th computing node for each i∈{0, . . . , M−1};
(h) the second dealer sending the i-th component Vᵢ of the second blinded vector V to the i-th computing node for each i∈{0, . . . , M−1};
(i) for each j∈{0, . . . , (M−1)}, the j-th computing node:
   calculating from its received components Uⱼ and Vⱼ a result share

$${R}_{j} = \frac{1}{M} {U}_{j} \cdot {V}_{j} ,$$

and
sending the result share Rⱼ to one or more of the one or more result nodes;
(j) said one or more result nodes calculating, from the M received result shares Rⱼ for j∈{0, . . . , M−1}, the inner product of the first and second private input vectors x, y as:

$$〈 x , y 〉 = {\sum }_{j = 0}^{M - 1} {R}_{j}$$

By making use of a transform for which Parseval's theorem holds, the method allows the dealer nodes to compute blinded vectors as Hadamard products which can be shared without revealing the private input vectors (i.e. the secrets). The computing nodes can then use shares of the blinded vectors to individually calculate result shares, without access to the secrets, and those result shares can be combined to compute the inner product of those secrets.

Preferably, the first and second dealer nodes generate the first and second private input vectors x and y of dimension M, respectively, as expansions of original unexpanded private input vectors x_{orig} and y_{orig} of dimension N, respectively, where N<M, and where:

$${x}_{orig} = ( {x}_{0} , {x}_{1} , … , {x}_{N - 1} ) \\ {y}_{orig} = ( {y}_{0} , {y}_{1} , … , {y}_{N - 1} ) \\ x = ( {x}_{0} , {x}_{1} , … , {x}_{N - 1} , {x}_{N} , … , {x}_{M - 1} ) \\ y = ( {y}_{0} , {y}_{1} , … , {y}_{N - 1} , {y}_{N} , … , {y}_{M - 1} )$$

and where the components x_{N}, . . . , x_{M-1} and y_{N}, . . . , y_{M-1} are chosen such that:

$${\sum }_{i = N}^{M - 1} {x}_{i} \cdot {y}_{i} = 0$$

In one embodiment, the steps of providing the first and second dealers with the random vectors A and A⁻¹ comprise both dealers operating a pseudo-random number generator in sync to generate the components of vector A, and the second dealer node calculating A⁻¹ from the vector A.

In another embodiment, the steps of providing the first and second dealers with the random vectors A and A⁻¹ comprise a trusted third party node communicating vector A to the first dealer node and either vector A or vector A⁻¹ to the second dealer node.

In yet a further embodiment, the steps of providing the first and second dealers with the random vectors A and A⁻¹ comprise communicating either vector A or vector A⁻¹ cryptographically to at least one of the first and second dealer nodes.

In an embodiment, the vector A is {1, 1, . . . , 1}.

In a further aspect, there is provided a computer-implemented method of performing a multi-party computation by a network of data processors, said data processors comprising first and second dealer nodes, a plurality of M computing nodes, and at least one result node, the method comprising:
(a) for each i∈{0, . . . , N−1} where N is the number of components of a first private input vector x=(x₀, x₁, . . . , x_{N-1}) known to the first dealer node and of a second private input vector y=(y₀, y₁, . . . , y_{M-1}) known to the second dealer node, providing the first dealer node with a transformed vector Uᵢ=(U_{i,0}, . . . , U_{i,M-1}) with components U_{i,j}, j∈{0, . . . , (M−1)} which is a transform of a random vector uᵢ=(u_{i,0}, u_{i,1}, . . . , u_{i,M-1}) according to a discrete linear transform for which Parseval's theorem holds;
(b) for each i∈{0, . . . , N−1}, providing the second dealer node with a transformed vector Vᵢ=(V_{i,0}, . . . , V_{i,M-1}) with components V_{i,j} j∈{0, . . . , (M−1)} which is a transform of a random vector vᵢ=(v_{i,0}, v_{i,1}, . . . , v_{i,M-1}) according to said discrete linear transform, wherein uᵢ and vᵢ satisfy the condition:

$${\sum }_{i = 0}^{N - 1} {\sum }_{j = 1}^{M - 1} {u}_{i , j} \cdot {v}_{i , j} = 0$$

(c) for each j∈{0, . . . , (M−1)}, providing the j-th computing node with each of the components U_{i,j} and V_{i,j} for i∈{0, . . . , N−1};
(d) for each i∈{0, . . . , N−1}, the first dealer node computing a scalar aᵢ=xᵢ−u_{i,0}, and the second dealer node computing a scalar bᵢ=yᵢ−v_{i,0};
(e) the first dealer sending to all computing nodes all of the scalars {a₀, . . . , a_{N-1}};
(f) the second dealer sending to all computing nodes all of the scalars {b₀, . . . , b_{N-1}};
(g) for each j∈{0, . . . , (M−1)}, the j-th computing node computing for each i∈{0, . . . , N−1} the transforms Aᵢ=(A_{i,0}, . . . , A_{i,M-1}) and Bᵢ=(B_{i,0}, . . . , B_{i,M-1}), wherein Aᵢ is the transform according to said discrete linear transform of a vector (aᵢ, 0, . . . , 0) and wherein Bᵢ is the transform according to said discrete linear transform of a vector (bᵢ, 0, . . . , 0);
(h) for each j∈{0, . . . , (M−1)}, the j-th computing node computing for each i∈{0, . . . , N−1}: C_{i,j}=U_{i,j}+A_{i,j} and D_{i,j}=V_{i,j}+B_{i,j};
(i) or each j∈{0, . . . , (M−1)}, the j-th computing node computing a result share:

$${R}_{j} = \frac{1}{M} {\sum }_{i = 0}^{N - 1} {C}_{i , j} \cdot {D}_{i , j}$$

(j) for each j∈{0, . . . , (M−1)}, the j-th computing node sending the result share to one or more of the one or more result nodes;
(k) said one or more result nodes calculating, from the M received result shares Rⱼ for j∈{0, . . . , M−1}, the inner product of the first and second private input vectors x, y as:

$$〈 x , y 〉 = {\sum }_{j = 0}^{M - 1} {R}_{j}$$

In this aspect we again make use of a transform for which Parseval's theorem holds, the method allowing the dealer nodes to compute blinded scalars which can be shared without revealing the private input vectors (i.e. the secrets). The computing nodes can then use shares of the blinded sums to individually calculate result shares, without access to the secrets, and those result shares can be combined to compute the inner product of those secrets.

In one embodiment, each dealer node independently generates random values u_{i,0}, v_{i,0}, i∈{0, . . . , N−1}, respectively, and completes the N vectors

$${u}_{i} = ( {u}_{i , 0} , {u}_{i , 1} , … , {u}_{i , M - 1} )$$

$${ν}_{i} = ( {v}_{i , 0} , {v}_{i , 1} , … , {v}_{i , M - 1} )$$

such that the condition Σᵢ₌₀^{N-1}Σⱼ₌₁^{M-1}u_{i,j}·v_{i,j}=0 holds.

In an embodiment, the first dealer node and second dealer node are programmed with rules to ensure that for any corresponding pair of vector components u_{i,j} and v_{i,j} and j>0, one of the pair is zero.

In an embodiment, the first dealer node and second dealer node are programmed with rules to ensure that for each i∈{0, . . . , N−1}, a first subset of indices j∈{1, . . . , (M−1)} are allocated for the first dealer node to set the vector components u_{i,j} equal to one, and a second subset of indices j∈{1, . . . , (M−1)} are allocated for the second dealer node to set the vector components v_{i,j} equal to one, with each dealer node setting the remaining components of its respective vector uᵢ or vᵢ to sum to zero.

In an embodiment, the first and second dealer nodes runs a pseudo-random generator in sync with one another, and wherein the values of the components u_{i,j} and v_{i,j} are identical and wherein at least one vector component is computed by at least one dealer node to ensure that

$${\sum }_{i = 0}^{N - 1} {\sum }_{j = 1}^{M - 1} {u}_{i , j} \cdot {v}_{i , j} = 0$$

In a further embodiment, the vectors uᵢ and vᵢ are collaboratively generated such that each pair of opposed components {u_{i,j}, v_{i,j}} for j∈{1, . . . , M−1} has one of the pair of components set to zero.

Preferably in this embodiment, the vectors uᵢ and vᵢ are of the form:

$${u}_{i} = ( {u}_{i , 0} , 0 , … , 0 , {u}_{i , ( M - 1 ) / 2 + 1} , … , {u}_{i , M - 1} ) ,$$

$${ν}_{i} = ( {v}_{i , 0} , {v}_{i , 1} , … , {v}_{i , ( M - 1 ) / 2} , 0 , … , 0 \} ,$$

where u_{i,0}, u_{i,(M-1)/2+1}, . . . , u_{i,M-1} and v_{i,0}, v_{i,1}, . . . , v_{i,(M-1)/2} are random or pseudo-random.

Further, preferably, the M computing nodes collaboratively compute the vectors uᵢ and vᵢ.

Further, preferably, the M computing nodes further collaboratively compute the transforms Uᵢ and Vᵢ.

Preferably, for each j∈{0, . . . , (M−1)}, the j-th computing node for each i∈{0, . . . , N−1}:
(i) generating a random share [u_{i,q}]ⱼ of component u_{i,q}, for q∈{0, (M−1)/2+1, . . . , M−1};
(ii) evaluating a public polynomial p(α), which satisfies p(0)=0, at α=αⱼ to obtain a share [0]ⱼ of every zero component of vector uᵢ;
(iii) generating a random share [v_{i,q}]ⱼ of component v_{i,q}, for q∈{0, 1, . . . , (M−1)/2;
(iv) evaluating said public polynomial p(α) at α=αⱼ to obtain a share [0]ⱼ of every zero component of vector vᵢ;
(v) locally computing a share of each component of the transformed vectors Uᵢ=(U_{i,0}, U_{i,1}, . . . , U_{i,M-1}), Vᵢ=(V_{i,0}, V_{i,1}, . . . , V_{i,M-1}) as follows:

$$\begin{matrix}{[ {U}_{i , k} ]}_{j} = {\sum }_{q = 0}^{M - 1} {{λ}_{k , q} [ {u}_{i , q} ]}_{j} \\ {[ {V}_{i , k} ]}_{j} = {\sum }_{q = 0}^{M - 1} {{λ}_{k , q} [ {v}_{i , q} ]}_{j}\end{matrix} i ∈ \{ 0 , … , N - 1 \} , k ∈ \{ 0 , … , M - 1 \}$$

where λ_{k,q} is an element of the transform matrix indexed as

$$( \begin{matrix}{λ}_{0 , 0} & … & {λ}_{0 , M - 1} \\ ⋮ & ⋱ & ⋮ \\ {λ}_{M - 1 , 0} & … & {λ}_{M - 1 , M - 1}\end{matrix} )$$

which acts on a vector cᵢ=(xᵢ, u_{i,1}, . . . , u_{i,M-1}) to generate its transformed vector Cᵢ=(C_{i,0}, . . . , C_{i,M-1}), i∈{0, . . . , N−1}:

$$( \begin{matrix}{C}_{i , 0} \\ {C}_{i , 1} \\ ⋮ \\ {C}_{i , M - 1}\end{matrix} ) = ( \begin{matrix}1 & 1 & & … & 1 \\ 1 & α & … & & {α}^{( M ‐ 1 )} \\ ⋮ & ⋮ & & ⋱ & ⋮ \\ 1 & {α}^{( M ‐ 1 )} & … & & {α}^{{( M ‐ 1 )}^{2}}\end{matrix} ) ( \begin{matrix}{x}_{i} \\ {u}_{i , 1} \\ ⋮ \\ {u}_{i , M - 1}\end{matrix} )$$

(vi) sending its shares [U_{i,k}]ⱼ, [V_{i,k}]ⱼ of the k-th component from the transformed vectors Uᵢ, Vᵢ to the k-th computing node, for k∈{0, . . . , M−1}; and
(vii) sending its shares [U_{i,k}]₀, . . . , [U_{i,k}]_{M-1} to the first dealer, and its shares [V_{i,k}]₀, . . . , [V_{i,k}]_{M-1} to the second dealer;
whereby the first and second dealers are provided with the shares necessary to reconstruct the transformed vectors Uᵢ=(U_{i,0}, U_{i,1}, . . . , U_{i,M-1}), Vᵢ=(V_{i,0}, V_{i,1}, . . . , V_{i,M-1}), i∈{0, . . . , N−1}, respectively; and
whereby the j-th computing node ends up with all the shares necessary to reconstruct U_{i,j} and V_{i,j}, for i∈{0, . . . , N−1} without learning either uᵢ=(u_{i,0}, u_{i,1}, . . . , u_{i,M-1}) or vᵢ=(v_{i,0}, v_{i,1}, . . . , v_{i,M-1}).

In another embodiment, the vectors uᵢ and vᵢ are collaboratively generated such that each component of pair of uᵢ and vᵢ is a random or pseudo-random number, other than one component of uᵢ or vᵢ which is chosen so that the condition: Σᵢ₌₀^{N-1}Σⱼ₌₁^{M-1}u_{i,j}·v_{i,j}=0 holds.

In a further embodiment, the vectors uᵢ and vᵢ are generated inside a trusted execution environment and communicated in encrypted form to the first and second dealer nodes respectively.

In a third aspect there is provided a computer-implemented method of performing a multi-party computation by a network of data processors, said data processors comprising first and second dealer nodes, a plurality of M computing nodes, and at least one result node, the method comprising:
(a) the first dealer node constructing a first set of N M-dimensional vectors {u₀, u₁ . . . , u_{N-1}} from a first private input vector x=(x₀, x₁, . . . , X_{N-1}) where:
   u₀=(x₀, u_{0,1}, . . . , u_{0,M-1}),
   u₁=(x₁, u_{1,1}, . . . , u_{1,M-1}), . . . ,
   u_{N-1}=(x_{N-1}, u_{N-1,1}, . . . , u_{N-1,M-1}),
(b) the second dealer node constructing a second set of N M-dimensional vectors {v₀, v₁ . . . , v_{N-1}} from a second private input vector y=(y₀, y₁, . . . , y_{N-1}) where:
   v₀=(y₀, v_{0,1}, . . . , v_{0,M-1})
   v₁=(y₁, v_{1,1}, . . . , v_{1,M-1}), . . . ,
   v_{N-1}=(y_{N-1}, v_{N-1,1}, . . . , v_{N-1,M-1}),
   wherein the vector components u_{i,j} and v_{i,j} satisfy the condition:

$${\sum }_{i = 0}^{N - 1} {\sum }_{j = 1}^{M - 1} {u}_{i , j} \cdot {v}_{i , j} = 0$$

(c) the first dealer node computing a respective transformed vector Uᵢ=(U_{i,0}, U_{i,1}, . . . , U_{i,M-1}) of each M-dimensional vector uᵢ of said first set, according to a discrete linear transform for which Parseval's theorem holds;
(d) the second dealer node computing a respective transformed vector Vᵢ=(V_{i,0}, V_{i,1}, . . . , V_{i,M-1}) of each M-dimensional vector vᵢ of said second set, according to said discrete linear transform;
(e) for each transformed vector Uᵢ for i∈{0, . . . , N−1}, the first dealer sending the j-th component U_{i,j} to the j-th computing node for j∈{0, . . . , M−1};
(f) for each transformed vector Vᵢ for i∈{0, . . . , N−1}, the second dealer sending the j-th component V_{i,j} to the j-th computing node for j∈{0, . . . , M−1};
(g) for each j∈{0, . . . , (M−1)}, the j-th computing node computing from the received components U_{i,j} and V_{i,j} for i∈{0, . . . , N−1} a result share Rⱼ where

$${R}_{j} = \frac{1}{M} {\sum }_{i = 0}^{N - 1} {U}_{i , j} \cdot {V}_{i , j}$$

(k) for each j∈{0, . . . , (M−1)}, the j-th computing node sending the result share Rⱼ to one or more of the one or more result nodes;
(l) said one or more result nodes calculating, from the M received result shares Rⱼ for j∈{0, . . . , M−1}, the inner product of the first and second private input vectors x, y as:

$$< x , y > = {\sum }_{j = 0}^{M - 1} {R}_{j}$$

In this aspect we again make use of a transform for which Parseval's theorem holds, the method allowing the dealer nodes to compute blinded vectors which can be shared without revealing the private input vectors (i.e. the secrets). The computing nodes can then use shares of the blinded vectors to individually calculate result shares, without access to the secrets, and those result shares can be combined to compute the inner product of those secrets.

In an embodiment, the first dealer node and second dealer node are programmed with rules to ensure that for any corresponding pair of vector components u_{i,j} and v_{i,j} one of the pair is zero.

Preferably, said rules ensure that for each i∈{0, . . . , N−1}, the indices j∈{0, . . . , (M−1)} are allocated between the first and second dealer nodes, with the first dealer node being allocated a first subset of indices for which the components u_{i,j} are zero, and the second dealer node being allocated a second subset of indices for which the components v_{i,j} are zero, and wherein the union of the first and second subsets is the set {0, . . . , (M−1)}.

Preferably, the first and second dealer nodes are programmed to set all components whose indices are not part of the first subset or second subset respectively allocated to that node to a random value.

In another embodiment, the first dealer node and second dealer node are programmed with rules to ensure that for each i∈{0, . . . , N−1}, a first subset of indices j∈{0, . . . , (M−1)} are allocated for the first dealer node to set the vector components u_{i,j} equal to one, and a second subset of indices j∈{0, . . . , (M−1)} are allocated for the second dealer node to set the vector components v_{i,j} equal to one, with each dealer node setting the remaining components of its respective vector uᵢ or vᵢ to sum to zero.

Preferably, each dealer node setting the remaining components of its respective vector uᵢ or vᵢ to sum to zero comprises setting a portion of the remaining components to a random value and the remainder of the remaining components to a value or values that ensure the aggregate remaining components sum to zero.

In another embodiment, the first and second dealer nodes run a pseudo-random generator in sync with one another, and wherein the values of the components u_{i,j} and v_{i,j} are identical and wherein at least one vector component is computed by at least one dealer node to ensure that

$${\sum }_{i = 0}^{N - 1} {\sum }_{j = 1}^{M - 1} {u}_{i , j} \cdot {v}_{i , j} = 0$$

For each aspect of the invention set out above, in some preferred embodiments, the private input vectors have integer components and arithmetical operations are performed modulo a prime number p.

Preferably, the discrete linear transform for which Parseval's theorem holds is selected from:
the Number Theoretic Transform (NTT);
the Fermat Number Transform (FNT);
the Mersenne Number Transform (MNT);
the Discrete Fourier Transform;
the Z-Transform;
the Discrete Hartley Transform;
the Discrete Wavelet Transform with arbitrary orthogonal wavelet bases, such as Haar, Daubechies, Simlets, Coiflets, Meyer, Morlet and Gaussian wavelet families.

In embodiments, the discrete linear transform is not the null function.

In embodiments, the discrete linear transform is not the identity function.

In other embodiments, the private input vectors can have real or complex number components.

### BRIEF DESCRIPTION OF THE DRAWINGS

FIG. 1 is a network diagram of a conventional SMPC network of dealer nodes, computing nodes and result nodes;

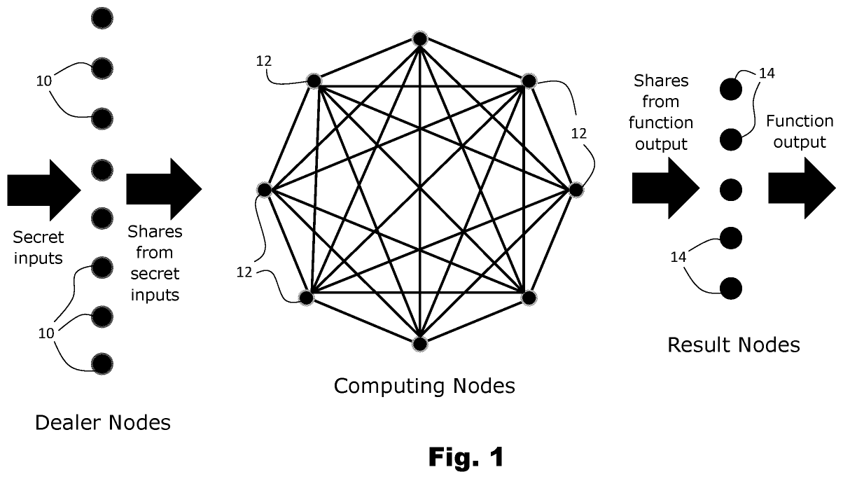

FIG. 2 is a message sequence chart showing the flows of messages between nodes in the protocol 2-NMC with Blinding Vectors;

FIG. 3 is a message sequence chart showing the flows of messages between nodes in the protocol 2-NMC with Blinding Sums;

FIG. 4 is a diagram illustrating the message flows involving a single computing node during a pre-processing stage usable with the protocol 2-NMC with Blinding Sums;

FIG. 5 is a message sequence chart showing the flows of messages between nodes during a different pre-processing stage usable with the protocol 2-NMC with Blinding Sums; and

FIG. 6 is a message sequence chart showing the flows of messages between nodes in the protocol 2-NMC with Blinding Products.

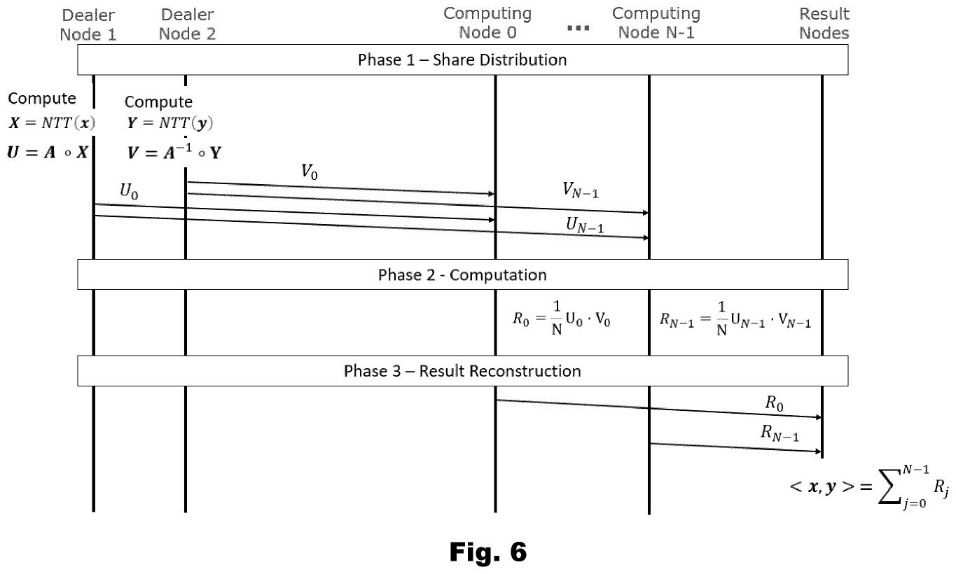

### DETAILED DESCRIPTION OF PREFERRED EMBODIMENTS

We recall from the introduction that the inner product, scalar product or dot product of two N-dimensional vectors x=(x₀, x₁, . . . , x_{N-1}) and y=(y₀, y₁, . . . , Y_{N-1}), represented as <x,y> is defined as:

$$< x , y > = {\sum }_{i = 0}^{N - 1} {x}_{i} \cdot {y}_{i} \qquad Eq . 1$$

The inner product requires the computation of N products in the arithmetic setting, and it also requires the computation of AND gates in the Boolean setting. This is therefore an example of a nontrivial function that leads to a slow evaluation in SMPC caused by the amount of bandwidth and the number of messages that computing nodes require to exchange. In this invention we present three new SMPC protocols which can compute the inner product between two vectors without the computing nodes having to exchange any message during the computation phase (Phase 2). These protocols allow computing in SMPC inner products between high dimensional vectors using a large number of computing nodes in essentially the same time as it would take in a centralized computation where both vectors are handled in clear in a server. We call these three protocols:
2-NMC with Blinding Vectors,
2-NMC with Blinding Sums, and
2-NMC with Blinding Products,

where NMC stands for Nil-Message Compute.

In the initial explanation of the three protocols we describe an implementation working with finite field arithmetic Z/pZ. That is, secrets are all represented as integers modulo p, where p is a prime number. All the computations that follow are therefore performed modulo p, represented as mod p. In what follows, sometimes we drop mod p for the sake of simplicity, but we will work with modular arithmetic unless explicitly stated.

The protocols make use of a discrete linear transform for which Parseval's theorem holds. The initial implementation, using finite field arithmetic Z/pZ, makes use of the Number Theoretic Transform (NTT) and its inverse, INTT. However, the skilled person should be aware in the description that follows that the NTT can be replaced by any other discrete linear transform for which Parseval's theorem holds.

In particular, it is envisaged that the different protocols can replace the use of NTT by any of the following:
The Fermat Number Transform (FNT) is used, whereby the modulus is a Fermat number Ft of the type Ft=2b+1, where b=2t, t=0, 1, 2, . . . .
The Mersenne Number Transform is used, whereby the modulus is a Mersenne number Mt of the type Mt=2q−1, where q is prime. In another setting the modulus is not a prime number.
The Discrete Fourier Transform is used, whereby the vectors can be of complex numbers.
The Z-Transform is used, whereby the vectors can be of complex numbers.
The Discrete Hartley Transform is used, whereby the vectors can be of real numbers.
The Discrete Wavelet Transform is used with arbitrary orthogonal wavelet bases (tight frames), such as Haar, Daubechies, Simlets, Coiflets, Meyer, Morlet and Gaussian wavelet families, whereby the vectors can be of complex numbers.

Furthermore the skilled person should bear in mind in what follows that while the protocols are described in terms of the private inputs known to a first dealer node and second dealer node, and while these dealer nodes may be distinct entities, the protocols are also applicable in cases where the two dealer nodes are not representative of different individuals, organisations, devices, computer systems, etc. For example, the two dealers may correspond to the same individual, organisation, device, etc., e.g. if dealer 1 is a user providing information about their face whilst signing up for an account, and dealer 2 is the same user who provides information about their face at login time (e.g. a day later).

We present, as different aspects of the present disclosure, three novel SMPC protocols that allow computing an inner product without requiring the nodes to exchange any message during the computation phase. Let us assume that two dealer nodes wish to compute the inner product between two vectors x=(x₀, x₁, . . . , x_{N-1}) and y=(y₀, y₁, . . . , y_{N-1}), whereby each dealer has one of the two vectors. Each dealer wants to keep their vector private and have a network of computing nodes evaluate the result from the inner product. The new SMPC protocols operate in the usual three phases: (1) share distribution, (2) computation, and (3) result reconstruction. We present the protocols in the following order:
1) 2-NMC with Blinding Vectors
2) 2-NMC with Blinding Sums
3) 2-NMC with Blinding Products

The characteristics of these protocols are summarised in the table below:

| | 2-NMC | 2-NMC | 2-NMC |
|---|---|---|---|
| | with | with | with |
| | Blinding | Blinding | Blinding |
| | Vectors | Sums | Products |
| Nodes exchange messages during | No | No | No |
| the Computation phase in SMPC | | | |
| Requires Pre-processing phase in | No | Yes | Yes |
| SMPC | | | |
| Number of shares required to store | N · M | M | M |
| N secrets in M computing nodes, | | | |
| assuming M>=N | | | |

The initially described implementation of all of the protocols are based on the Number Theoretic Transform (NTT), a specialization of the Discrete Fourier Transform (DFT) to the finite field Z/pZ of integers module a prime p.

Let α denote a root of unity of order N such that, α^{N}=1 (mod p). The NTT of a vector u=(u₀, u₁, . . . , u_{N-1}) and its inverse NTT (or INTT) are defined as follows:

$${\{ NTT ( u ) \}}_{k} = {\{ U \}}_{k} = {\sum }_{n = 0}^{N - 1} {u}_{n} \cdot {α}^{n k} mod p , k = 0 , 1 , … , N - 1$$

$${\{ INTT ( U ) \}}_{n} = {\{ u \}}_{n} = ( \frac{1}{N} {\sum }_{k = 0}^{N - 1} {U}_{k} \cdot {α}^{- n k} ) mod p , n = 0 , 1 , … , N - 1$$

That is, the NTT of a vector u=(u₀, u₁, . . . , u_{N-1}) is just another vector U=(U₀, U₁, . . . , U_{N-1}) of equal dimension.

Notice that the NTT is linear, that is:

$$N T T ( λ \cdot u + μ \cdot ν ) = λ \cdot NTT ( u ) + μ \cdot NTT ( ν )$$

where λ and μ are scalars. This property is fundamental for building a linear secret sharing mechanism based on the NTT.

Parseval's Theorem for the NTT states:

$$< a , b > {=}^{Δ} {\sum }_{n = 0}^{N - 1} {a}_{n} \cdot {b}_{n} = \frac{1}{N} {\sum }_{k = 0}^{N - 1} {A}_{k} \cdot {B}_{k} = \frac{1}{N} < A , B > \qquad Eq . 2$$

where a, b are N-dimensional vectors and A=NTT(a), and B=NTT(b) are their NTTs. This theorem establishes a relationship between sums of products of numbers and sums of products of their NTTs.

We now describe in turn the three protocols.

Protocol: 2-NMC with Blinding Vectors

Inputs: 2 dealer nodes, whereby dealers 1 and 2 contribute, respectively, with private inputs x=(x₀, x₁, . . . , x_{N-1}) and y=(y₀, y₁, . . . , y_{N-1}) to the computation of an inner product given by Eq. 1

Output: R result nodes reconstruct the inner product, which is computed by M computing nodes that are not able to see any of the input secrets.

Purpose: M computing nodes can jointly evaluate any arithmetic function with two dealers without any message exchange during the computation phase.

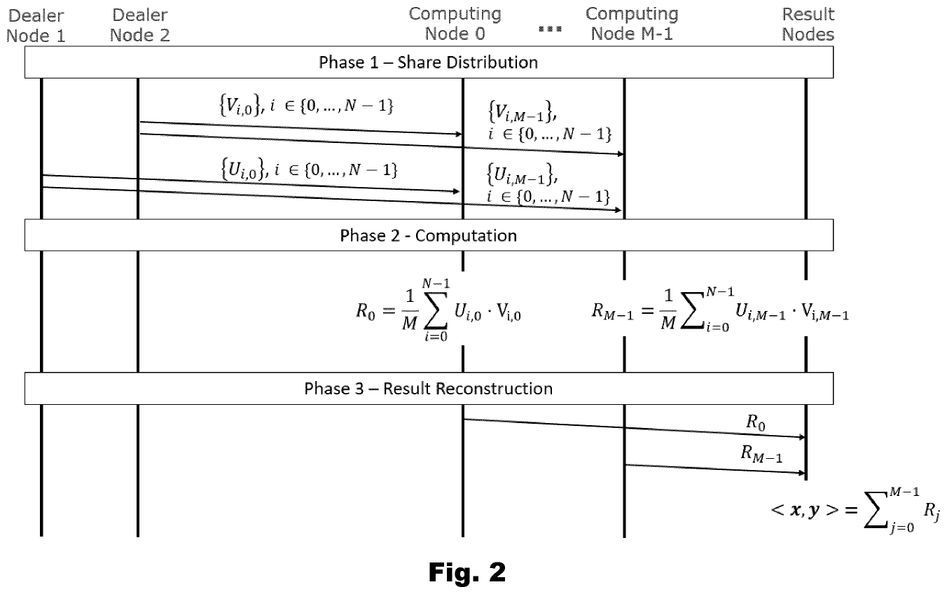

FIG. 2 provides a message sequence diagram showing the messages sent between the dealer nodes, computing nodes and result nodes, as detailed below.

### SMPC Phase 1: Share Distribution.

Step 1: Dealers 1 and 2 construct N M-dimensional vectors with their secret inputs

$${u}_{0} = ( {x}_{0} , {u}_{0 , 1} , … , {u}_{0 , M - 1} ) , \qquad Eq . 3$$

$${u}_{1} = ( {x}_{1} , {u}_{1 , 1} , … , {u}_{1 , M - 1} ) , … ,$$

$${u}_{N - 1} = ( {x}_{N - 1} , {u}_{N - 1 , 1} , … , {U}_{N - 1 , M - 1} ) ,$$

$$and$$

$${ν}_{0} = ( {y}_{0} , {v}_{0 , 1} , … , {v}_{0 , M - 1} ) ,$$

$${ν}_{1} = ( {y}_{1} , {v}_{1 , 1} , … , {v}_{1 , M - 1} ) , … ,$$

$${ν}_{N - 1} = ( {y}_{N - 1} , {v}_{N - 1 , 1} , … , {v}_{N - 1 , M - 1} ) , respectively , such that :$$

$${\sum }_{i = 0}^{N - 1} {\sum }_{j = 1}^{M - 1} {u}_{i , j} \cdot {v}_{i , j} = 0$$

Step 2: Dealers 1 and 2 compute the NTT of each one of their N vectors:

$$\begin{matrix}{U}_{i} = NTT ( {u}_{i} ) = ( {U}_{i , 0} , {U}_{i , 1} , … , {U}_{i , M - 1} ) \\ {V}_{i} = NTT ( {v}_{i} ) = ( {V}_{i , 0} , {V}_{i , 1} , … , {V}_{i , M - 1} )\end{matrix} i ∈ \{ 0 , … , N - 1 \}$$

where U_{i,j} and V_{i,j} are the j-th share of the i-th secret xᵢ and yᵢ from Dealers 1 and 2, respectively.
Step 3: Dealers 1 and 2 send the j-th share of each secret to the j-th computing node, for each j∈{0, . . . , M−1}.

At the end of this phase, the j-th computing node ends up with shares U_{i,j} and V_{i,j} for i∈{0, . . . , N−1}.

### SMPC Phase 2—Computation.

The j-th computing node calculates from the local shares it has received:

$${R}_{j} = \frac{1}{M} {\sum }_{i = 0}^{N - I} {U}_{i , j} \cdot {V}_{i , j} \qquad Eq . 4$$

### SMPC Phase 3—Result Reconstruction.

The j-th computing node sends Rⱼ in Eq. 4 to one or several result nodes, which then reconstruct the inner product as follows:

$$〈 x , y 〉 = {\sum }_{j = 0}^{M - 1} {R}_{j}$$

This ends the description of the Protocol 2-NMC with Blinding Vectors. We now prove the correctness of Eq. 4, and how privacy can be assured before describing details of some of the implementations for the pre-processing phase.

### Proof of Equation 4

We want to compute <x, y>. We have that:

$${\sum }_{i = 0}^{N - 1} 〈 {u}_{i} , {v}_{i} 〉 = {\sum }_{i = 0}^{N - 1} ( {x}_{i} \cdot {y}_{i} + {\sum }_{j = 1}^{M - 1} {u}_{i , j} \cdot {v}_{i , j} ) = {\sum }_{i = 0}^{N - 1} {x}_{i} \cdot {y}_{i} + {\sum }_{i = 0}^{N - 1} {\sum }_{j = 1}^{M - 1} {u}_{i , j} \cdot {v}_{i , j} = 〈 x , y 〉$$

where the last step derives from Eq. 3. Therefore, applying Parseval's theorem (Eq. 2) to every term <uᵢ, vᵢ> we have that

$$〈 {u}_{i} , {v}_{i} 〉 = \frac{1}{M} {\sum }_{i = 0}^{M - 1} {U}_{i , j} \cdot {V}_{i , j}$$

and so, from the equation above:

$$〈 x , y 〉 = \frac{1}{M} {\sum }_{i = 0}^{N - 1} {\sum }_{j = 0}^{M - 1} {U}_{i , j} \cdot {V}_{i , j}$$

We can rewrite this equation as <x, y>=Σⱼ₌₀^{M-1}Rⱼ, where

$${R}_{j} = \frac{1}{M} {\sum }_{i = 0}^{N - 1} {U}_{i , j} \cdot {V}_{i , j} .$$

Hence, each computing node j just needs to compute Eq. 4 to obtain the j-th term

$${R}_{j} = \frac{1}{M} {\sum }_{i = 0}^{N - 1} {U}_{i , j} \cdot {V}_{i , j} ,$$

and a result node just needs to add all Rⱼ to reconstruct <x, y>.

### Privacy

Notice also that according to the INTT, a vector uᵢ=(xᵢ, u_{i,1}, . . . , u_{i,M-1}) and its transformed vector Uᵢ=(U_{i,0}, U_{i,1}, . . . , U_{i,M-1}), i∈{0, . . . , N−1} are related through a linear system of M equations and M unknowns:

$$( \begin{matrix}{U}_{i , 0} \\ {U}_{i , 1} \\ ⋮ \\ {U}_{i , M - 1}\end{matrix} ) = ( \begin{matrix}1 & 1 & & … & 1 \\ 1 & α & … & & {α}^{( M - 1 )} \\ ⋮ & ⋮ & & ⋱ & ⋮ \\ 1 & {α}^{( M - 1 )} & … & & {α}^{{( M - 1 )}^{2}}\end{matrix} ) ( \begin{matrix}{x}_{i} \\ {u}_{i , 1} \\ ⋮ \\ {u}_{i , M - 1}\end{matrix} ) \qquad Eq . 5$$

Any bad actor gathering a subset of R transformed values {Uᵢ} with Uᵢ=(U_{i,0}, U_{i,1}, . . . , U_{i,M-1}) being the NTT of uᵢ=(xᵢ, u_{i,1}, . . . , u_{i,M-1}), where R≤M−1 will end up with a consistent but underdetermined linear system of equations with rank R. This system has an infinite number of solutions, with the general solution having F free parameters, where F is the difference between the number of variables M and the number of gathered transformed values R, that is, F=M−R. This means that a bad actor can only determine that there are infinite possible values for xᵢ, all equally probable. The same argument applies to any vector vᵢ=(yᵢ, v_{i,1}, . . . , v_{i,M-1}), i∈{0, . . . , N−1}.

We now proceed to describe different embodiments (or “settings”) that allow satisfying the condition given by Eq. 3 in Phase 1.

Setting 1: Setting Opposing Coordinates in Vectors uᵢ and vᵢ to 0

Let us assume that M−1 is even. In this setting, in Step 1 in Phase 1 of Protocol 2-NMC with Blinding Vectors, dealers 1 and 2 agree to set u_{i,1}, . . . , u_{i,(M-1)/2} and v_{i,(M-1)/2+1}, . . . , v_{i,M-1} to zero. That is, vectors uᵢ and vᵢ are of the form:

$${u}_{i} = ( {x}_{i} , 0 , … , 0 , {u}_{i , ( M - 1 ) / 2 + 1} , … , {u}_{i , M - 1} ) , {v}_{i} = ( {y}_{i} , {v}_{i , 1} , … , {v}_{i , ( M - 1 ) / 2} , 0 , … , 0 \} ,$$

where u_{i,(M-1)/2+1}, . . . , u_{i,M-1} and v_{i,1}, . . . , v_{i,(M-1)/2} are all random.

Notice that in this setting Eq. 3 holds since all products between opposing components other than the first one contains a zero. In a related setting, dealers 1 and 2 agree on a different arrangement of 0's. Any arrangement whereby opposing components other than the first one contains a zero is valid.

Setting 2: Setting Opposing Coordinates in Vectors uᵢ and vᵢ to 1

Let us assume that M−1 is even. In this setting, in Step 1 in Phase 1 of Protocol 2-NMC with Blinding Vectors, dealers 1 and 2 agree to set u_{i,2j+1}=1 and v_{i,2j}=1 for all values of j and i. Then dealers 1 and 2 randomly and independently generate the rest of their vector, except for the last coordinate which is chosen so that, respectively:

$${\sum }_{i = 0}^{N - 1} {{\sum }_{j = 1}}^{( M - 1 ) / 2} {u}_{i , 2 j} = 0 \\ {\sum }_{i = 0}^{N - 1} {{\sum }_{j = 0}}^{( M - 1 ) / 2 - 1} {v}_{i , 2 j + 1} = 0$$

Notice that these conditions imply Eq. 3, since:

$${\sum }_{i = 0}^{N - 1} {\sum }_{j = 1}^{M - 1} {u}_{i , j} \cdot {v}_{i , j} = {\sum }_{i = 0}^{N - 1} {\sum }_{j = 1}^{( M - 1 ) / 2} {u}_{i , 2 j} \cdot {v}_{i , 2 j} + {\sum }_{i = 0}^{N - 1} {\sum }_{j = 0}^{( M - 1 ) / 2 - 1} {u}_{i , 2 j + 1} \cdot {v}_{i , 2 j + 1} = {\sum }_{i = 0}^{N - 1} {\sum }_{j = 1}^{( M - 1 ) / 2} {u}_{i , 2 j} + {\sum }_{i = 0}^{N - 1} {\sum }_{j = 0}^{( M - 1 ) / 2 - 1} {v}_{i , 2 j + 1} == 0$$

Here we are assuming that (M−1) is even. If it is odd, the conditions become

$${\sum }_{i = 0}^{N - 1} {\sum }_{j = 1}^{( M - 2 ) / 2} {u}_{i , 2 j} = 0 and {\sum }_{i = 0}^{N - 1} {\sum }_{j = 0}^{( M - 2 ) / 2} {v}_{i , 2 j + 1} = 0 .$$

The advantage of this setting is that it allows dealers 1 and 2 to independently (i.e., with no communication) set up their vectors uᵢ, and vᵢ, respectively.

In a related setting, dealers 1 and 2 agree on a different arrangement of 1's. For example, uᵢ has the even values in j equal to 1 and vᵢ the odd ones. In another example, uᵢ has the first half of (M−1)/2 values in j equal to 1 and vᵢ the second half. Other arrangements are possible. The important condition is that in each product u_{i,j}·v_{i,j} one of the two vector components is equal to 1.

### Setting 3: Pseudo-Random Number Generators in Sync

In this set setting up, in Step 1 in Phase 1 of Protocol 2-NMC with Blinding Vectors, dealers 1 and 2 use each one a pseudo-random number generator in sync such that they produce the same vector components. This way, dealers 1 and 2 independently generate u_{i,j}, i∈{0, . . . , N−1}, j∈{0, . . . , M−1} and v_{i,j}, i∈{0, . . . , N−1}, j∈{0, . . . , M−2}. Then, dealer 2 sets

$${v}_{N - 1 , M - 1} = - {U}_{N - 1 , M - 1}^{– 1} \cdot {\sum }_{i = 0}^{N - 1} {\sum }_{j = 0}^{M - 2} {u}_{i , j} \cdot {v}_{i , j} \qquad Eq . 6$$

so that Eq. 3 holds. As long as the two pseudo-random number generators operate in sync this setting does not require communication between the two dealers.

In a related setting, a vector component different from v_{N-1,M-1} is nonrandomly chosen so that Eq. 3 holds. In a related setting it is dealer 1 the one that sets the value of a component in vector uᵢ so that Eq. 3 holds.

Notice that the 2-NMC with Blinding Vectors Protocol requires each dealer to send N·M shares of their N inputs (the components of their vector). That is, each secret vector component requires M shares. This is the same secret-to-share ratio as observed in many other SMPC protocols such as GMW, BGW, SPDZ, BMR, and GESS.

The following two protocols allow reducing this ratio to 1. That is, N secret vector components require only N shares. Both protocols make use of a pre-processing phase.

Protocol: 2-NMC with Blinding Sums

Inputs: 2 dealer nodes, whereby dealers 1 and 2 contribute, respectively, with private inputs x=(x₀, x₁, . . . , x_{N-1}) and y=(y₀, y₁, . . . , y_{N-1}) to the computation of an inner product given by Eq. 1

Output: R result nodes reconstruct the inner product, which is computed by M computing nodes that are not able to see any of the input secrets.

Purpose: M computing nodes can jointly evaluate any arithmetic function with two dealers without any message exchange during the computation phase.

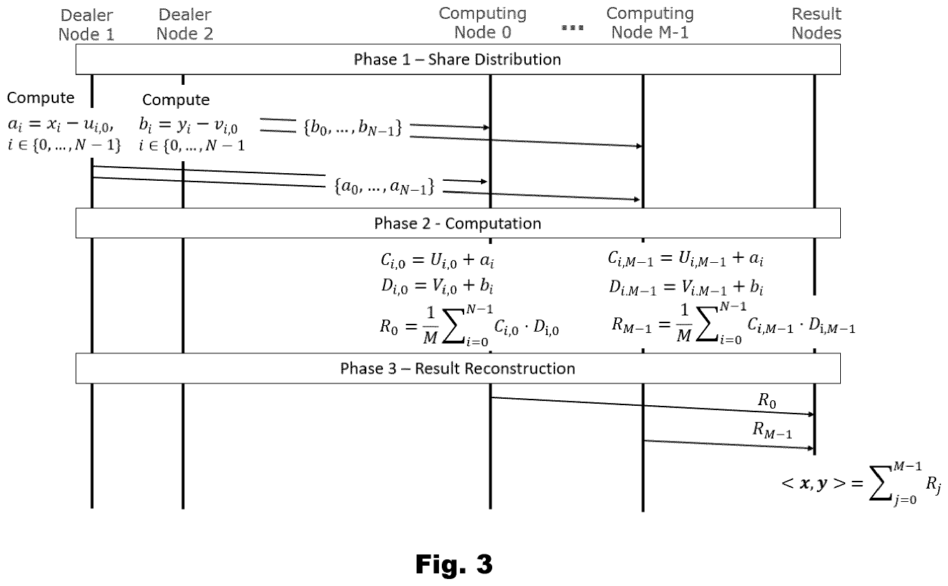

FIG. 3 provides a message sequence diagram showing the messages sent between the dealer nodes, computing nodes and result nodes, as detailed below.

### SMPC Phase 0: Pre-Processing.

The computing nodes and dealers 1 and 2 run a pre-processing phase such that for each i∈{0, . . . , N−1}:
Condition 1: Dealer 1 ends up with a transformed vector Uᵢ=(U_{i,0}, . . . , U_{i,M-1}) with components U_{i,j}, j∈{0, . . . , (M−1)} such that its INTT is a random vector uᵢ=(u_{i,0}, u_{i,1}, . . . , u_{i,M-1})
Condition 2: Dealer 2 ends up with a transformed vector Vᵢ=(V_{i,0}, . . . , V_{i,M-1}) with components V_{i,j}, j∈{0, . . . , (M−1)} such that its INTT is a random vector vᵢ=(uv_{i,0}, v_{i,1}, . . . , v_{i,M-1})
Condition 3: The j-th computing node ends up with Uᵢ, and V_{i,j}, for j∈{0, . . . , M−1} but knows neither uᵢ=(u_{i,0}, u_{i,1}, . . . , u_{i,M-1}) nor vᵢ=(v_{i,0}, v_{i,1}, . . . , v_{i,M-1})
Condition 4: Vectors uᵢ and vᵢ fulfil

$${\sum }_{i = 0}^{N - 1} {\sum }_{j = 1}^{M - 1} {u}_{i , j} \cdot {v}_{i , j} = 0 \qquad Eq . 3$$

Notice that this phase is independent of the actual private inputs x=(x₀, x₁, . . . , x_{N-1}) and y=(y₀, y₁, . . . , y_{N-1}) of the SMPC computation. For this reason, this is a pre-processing phase which can be executed before the actual SMPC computation takes place (hours, days, months, etc.), having no impact on its performance.

### SMPC Phase 1: Share Distribution.

Step 1: For each i∈{0, . . . , N−1}:
   Applying the INTT to Uᵢ=(U_{i,0}, . . . , U_{i,M-1}) dealer 1 computes u_{i,0} and defines a scalar aᵢ=xᵢ−u_{i,0}. Given that u_{i,0} is unknown to the computing nodes (see Condition 3 in the pre-processing phase), aᵢ is a blinded version of private input xᵢ
   Applying the INTT to Vᵢ=(V_{i,0}, . . . , V_{i,M-1}) dealer 2 computes v_{i,0} and defines a scalar bᵢ=yᵢ−v_{i,0}. Given than v_{i,0} is unknown to the computing nodes (see Condition 3 in the pre-processing phase), bᵢ is a blinded version of private input yᵢ
Step 2:
   Dealer 1 sends one broadcast message to all compute nodes with the collection of blinded private inputs {a₀, . . . , a_{N-1}}
   Dealer 2 sends one broadcast message to all computing nodes with the collection of blinded private inputs {b₀, . . . , b_{N-1}}

### SMPC Phase 2—Computation.

For j∈{0, . . . , M−1}, the j-th computing node follows these steps:
Step 1: For each i∈{0, . . . , N−1}, build vectors (aᵢ, 0, . . . , 0), (bᵢ, 0, . . . , 0) and compute their NTT Aᵢ=(A_{i,0}, . . . , A_{i,M-1}), Bᵢ=(B_{i,0}, . . . , B_{i,M-1}), which from its definition turns out to be equal to Aᵢ=(aᵢ, . . . , aᵢ), Bᵢ=(bᵢ, . . . , bᵢ).
Step 2: For each i∈{0, . . . , N−1}, compute
   C_{i,j}=U_{i,j}+A_{i,j}, and
   D_{i,j}=V_{i,j}+B_{i,j}
Step 3: Compute:

$${R}_{j} = \frac{1}{M} {\sum }_{i = 0}^{N - 1} {C}_{i , j} \cdot {D}_{i , j} \qquad Eq . 4$$

### SMPC Phase 3—Result Reconstruction.

The j-th computing node sends Rⱼ in Eq. 4 to one or several result nodes, which then reconstruct the inner product as follows:

$$< x , y > = {\sum }_{j = 0}^{M - 1} {R}_{j}$$

This ends the description of the Protocol 2-NMC with Blinding Sums. We now prove the correctness of Eq. 4 in this protocol, and how privacy can be assured before describing details of some of the implementations for the pre-processing phase.

### Proof for Eq. 4

Let us denote by NTT{(h₀, . . . , h_{N-1})}=(H₀, . . . , H_{N-1}) to the NTT of a vector (h₀, . . . , h_{N-1}). From the linearity property of the NTT we have for each i∈{0, . . . , N−1} that:

$$NTT \{ ( {x}_{i} , {u}_{i , 1} , … , {u}_{i , M - 1} ) \} = NTT \{ ( {u}_{i , 0} , {u}_{i , 1} , … , {u}_{i , M - 1} ) + ( {a}_{i} , 0 , … , 0 ) \} = NTT \{ ( {u}_{i , 0} , {u}_{i , 1} , … , {u}_{i , M - 1} ) \} + NTT \{ ( {a}_{i} , 0 , … , 0 ) \} = ( {U}_{i , 0} , … , {U}_{i , M - 1} ) + ( {A}_{i , 0} , … , {A}_{i , M - 1} ) = ( {C}_{i , 0} , … , {C}_{i , M - 1} )$$

That is, Cᵢ=(C_{i,0}, . . . , C_{i,M-1})=(U_{i,0}+A_{i,0}, . . . , U_{i,M-1}+A_{i,M-1})=Uᵢ+Aᵢ is the NTT of vector cᵢ=(xᵢ, u_{i,1}, . . . , u_{i,M-1}). The same applies to Dᵢ=(D_{i,0}, . . . , D_{i,M-1})=Vᵢ+Bᵢ, which is the NTT of vector dᵢ=(yᵢ, v_{i,1}, . . . , v_{i,M-1}).

Notice that:

$${\sum }_{i = 0}^{N - 1} < {c}_{i} , {d}_{i} > = {\sum }_{i = 0}^{N - 1} ( {x}_{i} \cdot {y}_{i} + {\sum }_{j = 1}^{M - 1} {u}_{i , j} \cdot {v}_{i , j} ) = {\sum }_{i = 0}^{N - 1} {x}_{i} \cdot {y}_{i} + {\sum }_{i = 0}^{N - 1} {\sum }_{j = 1}^{M - 1} {u}_{i , j} \cdot {v}_{i , j} = < x , y >$$

where the last step derives from Eq. 3.

Applying Parseval's theorem (Eq. 2) to every term <cᵢ, dᵢ> we have that:

$$< {c}_{i} , {d}_{i} > = \frac{1}{M} {\sum }_{j = 0}^{M - 1} {C}_{i , j} \cdot {D}_{i , j}$$

Replacing this term in the equation above we have that:

$$< x , y > = \frac{1}{M} {\sum }_{i = 0}^{N - 1} {\sum }_{j = 0}^{M - 1} {C}_{i , j} \cdot {D}_{i , j} = {\sum }_{j = 0}^{M - 1} \frac{1}{M} {\sum }_{i = 0}^{N - 1} {C}_{i , j} \cdot {D}_{i , j} = {\sum }_{j = 0}^{M - 1} {R}_{j}$$

where

$${R}_{j} = \frac{1}{M} {\sum }_{i = 0}^{N - 1} {C}_{i , j} \cdot {D}_{i , j} .$$

Hence, each computing node j just needs to locally compute Eq. 4 to obtain the j-th term

$${R}_{j} = \frac{1}{M} {\sum }_{i = 0}^{N - 1} {C}_{i , j} \cdot {D}_{i , j} ,$$

and a result node just needs to add all Rⱼ to reconstruct <x, y>

### Privacy

Notice that according to the NTT, a vector cᵢ=(xᵢ, u_{i,1}, . . . , u_{i,M-1}) and its transformed vector Cᵢ=(C_{i,0}, . . . , C_{i,M-1}), i∈{0, . . . , N−1} are related through a linear system of M equations and M unknowns:

$$( \begin{matrix}{C}_{i , 0} \\ {C}_{i , 1} \\ ⋮ \\ {C}_{i , M - 1}\end{matrix} ) = ( \begin{matrix}1 & 1 & & … & 1 \\ 1 & α & … & & {α}^{( M ‐ 1 )} \\ ⋮ & ⋮ & & ⋱ & ⋮ \\ 1 & {α}^{( M ‐ 1 )} & … & & {α}^{{( M ‐ 1 )}^{2}}\end{matrix} ) ( \begin{matrix}{x}_{i} \\ {u}_{i , 1} \\ ⋮ \\ {u}_{i , M - 1}\end{matrix} ) \qquad Eq . 5$$

The computing nodes only see and store components from transformed vectors. Any bad actor gathering a subset of R transformed values from vector Cᵢ=(C_{i,0}, . . . , C_{i,M-1}), with R≤M−1 will end up with a consistent but underdetermined linear system of equations with rank R. This system has an infinite number of solutions, with the general solution having F free parameters, where F=M−R is the difference between the number of variables M and the number of gathered transformed values R. This means that a bad actor can only determine that there are infinite possible values for xᵢ, all equally probable. The same argument applies to any vector dᵢ=(yᵢ, v_{i,1}, . . . , v_{i,M-1}), i∈{0, . . . , N−1}.

We now describe possible implementations or settings for the pre-processing phase in this protocol. Settings 1, 2 and 3 from protocol 2-NMC with Blinding Vectors can be easily adapted to this purpose. The main difference is that in protocol 2-NMC with Blinding Vectors the first component of vectors uᵢ and vᵢ constitute input data xᵢ and yᵢ to the computation, whereas in the pre-processing phase of protocol 2-NMC with Blinding Sums the first components u_{i,0}, v_{i,0} of these vectors uᵢ, vᵢ are random numbers. Thus, dealers 1 and 2 can proceed as follows:
Step 1: Each dealer independently generates random values u_{i,0}, v_{i,0}, i∈{0, . . . , N−1}, respectively,
Step 2: Dealers 1 and 2 execute Setting 1, 2, or 3 from protocol 2-NMC with Blinding Vectors to complete, respectively, N vectors

$${u}_{i} = ( {u}_{i , 0} , {u}_{i , 1} , … , {u}_{i , M - 1} )$$

$${ν}_{i} = ( {v}_{i , 0} , {v}_{i , 1} , … , {v}_{i , M - 1} )$$

such that Eq. 3 holds.
Step 3: Dealers 1 and 2 compute the NTT of each one of their N vectors:

$$\begin{matrix}{U}_{i} = NTT ( {u}_{i} ) = ( {U}_{i , 0} , {U}_{i , 1} , … , {U}_{i , M - 1} ) \\ {V}_{i} = NTT ( {ν}_{i} ) = ( {V}_{i , 0} , {V}_{i , 1} , … , {V}_{i , M - 1} )\end{matrix} i ∈ \{ 0 , … , N - 1 \}$$

Step 3: Dealers 1 and 2 send U_{i,j} and V_{i,j} for i∈{0, . . . , N−1} to the j-th computing node, for each j∈{0, . . . , M−1}.

In these three settings dealers 1 and 2 compute Uᵢ and Vᵢ, and then distribute their components U_{i,j} and V_{i,j} among the computing nodes. In other settings, it might be desirable for the computing nodes to be the ones that collaboratively compute Uᵢ and Vᵢ, as described in the following two settings.

We denote by [s]ⱼ to the j-th SSS (Shamir's Secret Sharing) share from a private input s. We also simplify notation and denote by

$$( \begin{matrix}{λ}_{0 , 0} & … & {λ}_{0 , M - 1} \\ ⋮ & ⋱ & ⋮ \\ {λ}_{M - 1 , 0} & … & {λ}_{M - 1 , M - 1}\end{matrix} )$$

to the linear transform matrix from the NTT given by Eq. 5. Both, the NTT and SSS operate modulo the same prime number p. The computing nodes all agree on a public polynomial p(α) such that p(0)=0 and according to SSS the j-th node is assigned a public abscissa αⱼ.

Setting 4: BGW with Opposing Zeros

In this setting, the computing nodes collaboratively generate vectors uᵢ and vᵢ of the form:

$${u}_{i} = ( {u}_{i , 0} , 0 , … , 0 , {u}_{i , ( M - 1 ) / 2 + 1} , … , {u}_{i , M - 1} ) ,$$

$${ν}_{i} = ( {v}_{i , 0} , {v}_{i , 1} , … , {v}_{i , ( M - 1 ) / 2} , 0 , … , 0 \} ,$$

where u_{i,0}, u_{i,(M-1)/2+1}, . . . , u_{i,M-1} and v_{i,0}, v_{i,1}, . . . , v_{i,(M-1)/2} are all random. The computing nodes also collaboratively compute their NTT transforms Uᵢ and Vᵢ. Notice that vectors uᵢ and vᵢ have the same structure as in Setting 1. The main difference is that here the computing nodes (and not the dealers) generate these vectors. Notice also that it is fundamental that the computing nodes are not able to access u_{i,0}, v_{i,0} since in Step 2 in Phase 1 they receive aᵢ, bᵢ, which would allow them to compute the private inputs xᵢ=aᵢ+u_{i,0}, yᵢ=bᵢ+v_{i,0}. This setting makes use of Shamir's Secret Sharing (SSS) and BGW SMPC.

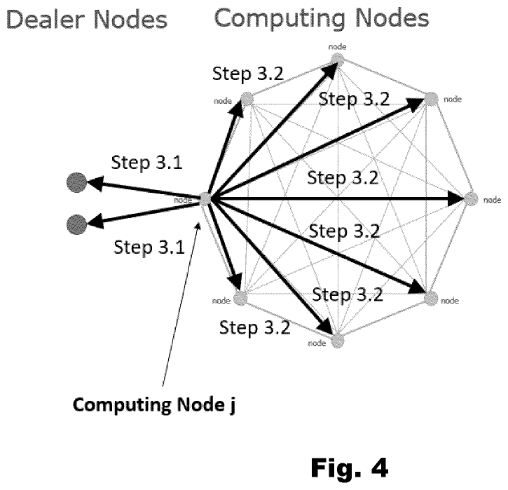

For every i∈{0, . . . , N−1}, each computing node j∈{0, . . . , M−1} performs the following steps (see FIG. 4, which illustrates the message flows in relation to a single computing node j):

Step 1: Computing node j locally computes its share from each component of vectors uᵢ, vᵢ as follows:
Vector uᵢ:
   Share [u_{i,q}]ⱼ of component u_{i,q} is randomly generated, for q∈{0, (M−1)/2+1, . . . , M−1}
   Share [0]ⱼ of every zero component is obtained by evaluating p(α) at α=αⱼ
Vector vᵢ:
   Share [v_{i,q}]ⱼ of component v_{i,q} is randomly generated, for q∈{0, 1, . . . , (M−1)/2}
   Share [0]ⱼ of every zero component is obtained by evaluating p(α) at α=αⱼ

Step 2: Computing node j locally computes a share of each component of the transformed vectors Uᵢ=(U_{i,0}, U_{i,1}, . . . , U_{i,M-1}), Vᵢ=(V_{i,0}, V_{i,1}, . . . , V_{i,M-1}) applying the linearity of SSS as follows:

$$\begin{matrix}{[ {U}_{i , k} ]}_{j} = {\sum }_{q = 0}^{M - 1} {{λ}_{k , q} [ {u}_{i , q} ]}_{j} \\ {[ {V}_{i , k} ]}_{j} = {\sum }_{q = 0}^{M - 1} {{λ}_{k , q} [ {v}_{i , q} ]}_{j}\end{matrix} i ∈ \{ 0 , … , N - 1 \} , k ∈ \{ 0 , … , M - 1 \}$$

Step 3: Each computing node, for every i∈{0, . . . , N−1}, k∈{0, . . . , M−1}:
Sends its shares [U_{i,k}]ⱼ, [V_{i,k}]ⱼ of the k-th component from the transformed vectors Uᵢ, Vᵢ to the k-th computing node, for k∈{0, . . . , M−1}
Sends its shares [U_{i,k}]₀, . . . , [U_{i,k}]_{M-1} to dealer 1, and its shares [V_{i,k}]₀, . . . , [V_{i,k}]_{M-1} to dealer 2.

Notice that Steps 1 and 2 do not require any message exchange.

At the end of this setting:
Dealers 1 and 2 end up with all the shares necessary to reconstruct their transformed vectors Uᵢ=(U_{i,0}, U_{i,1}, . . . , U_{i,M-1}), Vᵢ=(V_{i,0}, V_{i,1}, . . . , V_{i,M-1}), i∈{0, . . . , N−1}, respectively
The j-th computing node ends up with all the shares necessary to reconstruct U_{i,j} and V_{i,j}, for i∈{0, . . . , N−1}, but knows neither uᵢ=(u_{i,0}, u_{i,1}, . . . , u_{i,M-1}) nor vᵢ=(v_{i,0}, v_{i,1}, . . . , v_{i,M-1}), and
Eq. 3 holds. This follows from the structure of vectors uᵢ and vᵢ (see discussion in Setting 1).

Thus, all the requirements for Phase 0 in protocol 2-NMC with Blinding Sums are met.

In the steps above, the reconstruction of a number from its shares is done using SSS, typically using Lagrange polynomial interpolation.

In a related setting, the computing nodes all agree on a different public polynomial p(α) such that p(0)=0 for each one of the zeros in vectors uᵢ and vᵢ. In a related setting the zeros in vectors uᵢ and vᵢ are located in different opposing positions.

### Setting 5: BGW

In this setting we adapt Setting 4 to the case in which the computing nodes collaboratively generate vectors uᵢ and vᵢ of the form:

$${u}_{i} = ( {u}_{i , 0} , {u}_{i , 1} , … , {u}_{i , M - 1} ) ,$$

$${ν}_{i} = ( {v}_{i , 0} , {v}_{i , 1} , … , {v}_{i , M - 1} \} ,$$

where all components are random numbers, except for one of them, say v_{N-1,M-1}, that fulfils Eq. 6:

$${v}_{N - 1 , M - 1} = - {u}_{N - 1 , M - 1}^{- 1} \cdot {\sum }_{i = 0}^{N - 1} {\sum }_{j = 0}^{M - 2} {u}_{i , j} \cdot {v}_{i , j} \qquad Eq . 6$$

so that Eq. 3 holds.

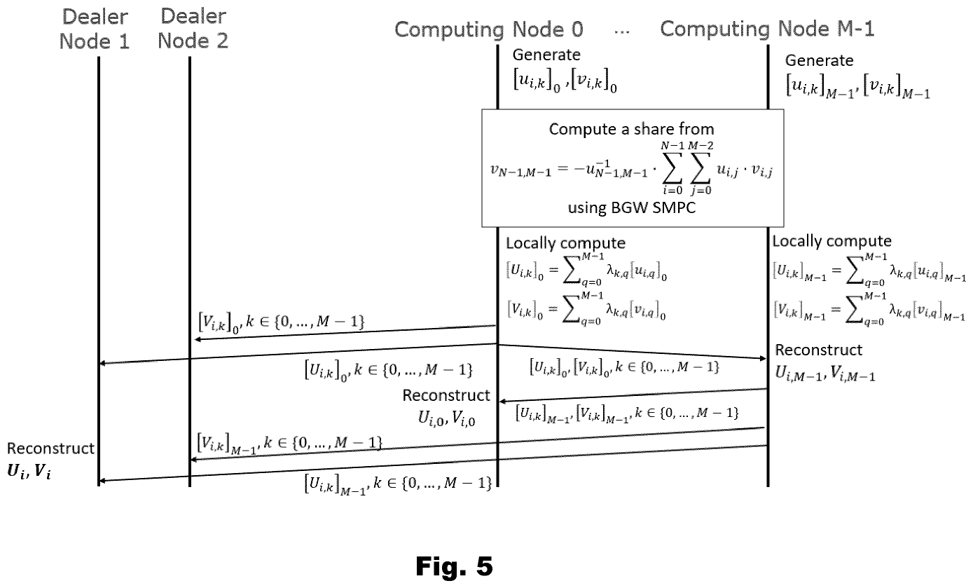

For every i∈{0, . . . , N−1}, each computing node j∈{0, . . . , M−1} performs the following steps (see FIG. 5):

Step 1: Computing node j computes its share from each component of vectors uᵢ, vᵢ as follows:
Vector uᵢ:
   Share [u_{i,k}]ⱼ of component u_{i,k} is randomly generated, for k∈{0, 1, . . . , M−1}
Vector vᵢ:
   Share [v_{i,k}]ⱼ of component v_{i,k} is randomly generated, for k∈{0, 1, . . . , M−1}

The computing nodes run BGW SMPC, and computing node j ends up with a share [v_{N-1,M-1}]ⱼ of v_{N-1,M-1} such that Eq. 6 holds. Note that this requires the evaluation in BGW of M products, M−1 of which can be computed in parallel (Σⱼ₌₀^{M-2}u_{i,j}·v_{i,j}). This requires the computing nodes to exchange messages.

Step 2: Like in Setting 4

Step 3: Like in Setting 4

In a related setting, the computing nodes run a different type of SMPC in Step 1, including BGW with Beaver's triples and SPDZ, to obtain the j-th node a share [v_{N-1,M-1}]ⱼ of v_{N-1,M-1} such that Eq. 6 holds. In a related setting, a vector component different from v_{N-1,M-1} is nonrandomly chosen so that Eq. 3 holds. In a related setting the value of a component in vector uᵢ is the one nonrandomly chosen so that Eq. 3 holds.

In another setting, it might be desirable to use secure hardware, as described below.

### Setting 6: Trusted Execution Environments

In this setting, a 3^{rd} party generates vectors uᵢ, vᵢ fulfilling Eq. 3. inside of a trusted execution environment or secure enclave and sends each one of them to a dealer in encrypted form so that only they can decrypt it using their private key.

In another setting, the computing nodes run in parallel many instances of the pre-processing phase in protocol 2-NMC with Blinding Sums so that they are ready to support the execution of a large number of Phases 1, 2 and 3 of this protocol.

Protocol: 2-NMC with Blinding Products

Inputs: 2 dealer nodes, whereby dealers 1 and 2 contribute, respectively, with private inputs x=(x₀, x₁, . . . , x_{N-1}) and y=(y₀, y₁, . . . , y_{N-1}) to the computation of an inner product given by Eq. 1

Output: R result nodes reconstruct the inner product, which is computed by N computing nodes that are not able to see any of the input secrets.

Purpose: N computing nodes can jointly evaluate any arithmetic function with two dealers without any message exchange during the computation phase.

### SMPC Phase 0: Pre-Processing

Step 1: Dealers 1 and 2 compute or receive the same random vector A=(A₀, A₁, . . . , A_{N-1}) with no components equal to zero.
Step 2: Dealer 2 computes its inverse modulo p (which is defined since p is prime) A⁻¹=(A₀⁻¹, A₁⁻¹, . . . , A_{N-1}⁻¹)

### SMPC Phase 1: Share Distribution.

Step 1: Dealers 1 and 2 compute the NTT of their vectors:

$$X = N T T ( x ) = ( {X}_{0} , {X}_{1} , … , {X}_{N - 1} )$$

$$y = NT T ( y ) = ( {Y}_{0} , {Y}_{1} , … , {Y}_{N - 1} )$$

Step 2: Let ∘ represent the Hadamard product:

$$Dealer 1 computes U = A \cdot X ,$$

$$Dealer 2 computes V = {A}^{- 1} \cdot Y$$

where Uᵢ and Vᵢ are the i-th share of vectors x and y from Dealers 1 and 2, respectively.
Step 3: Dealers 1 and 2 send the i-th share of each secret to the i-th computing node, for each i∈{0, . . . , N−1}.

At the end of this phase, the i-th computing node ends up with two shares Uᵢ and Vᵢ.

### SMPC Phase 2—Computation.

The j-th computing node calculates from the local shares it has received:

$${R}_{j} = \frac{1}{N} {U}_{j} \cdot {V}_{j} \qquad Eq . 4$$

### SMPC Phase 3—Result Reconstruction.

The j-th computing node sends Rⱼ in Eq. 4 to one or several result nodes, which then reconstruct the inner product as follows:

$$< x , y > = {\sum }_{j = 0}^{N - 1} {R}_{j}$$

This ends the description of the Protocol 2-NMC with Blinding Products. We now prove the correctness of Eq. 4 in this protocol, and how privacy can be assured before describing details of some of the implementations for the pre-processing phase.

### Proof for Eq. 4

We have that:

$${\sum }_{j = 0}^{N - 1} {R}_{j} = \frac{1}{N} {\sum }_{j = 0}^{N - 1} {U}_{j} \cdot {V}_{j} = \frac{1}{N} {\sum }_{j = 0}^{N - 1} {A}_{j} \cdot {X}_{j} \cdot {A}_{j}^{- 1} \cdot {Y}_{j} = \frac{1}{N} {\sum }_{j = 0}^{N - 1} {X}_{j} \cdot {Y}_{j} = < x , y >$$

where the last step follows from Parseval's Theorem. Thus, by adding Rⱼ one or several result nodes can reconstruct the inner product <x, y>

### Privacy.

The shares are the result of multiplying component-wise the NTT by a random vector bringing privacy into this secret sharing mechanism.

### Different Implementations for the Pre-Processing Phase

We now provide different settings that describe possible ways of providing Dealers 1 and 2 with random vectors A=(A₀, A₁, . . . , A_{N-1}), and A⁻¹=(A₀⁻¹, A₁⁻¹, . . . , A_{N-1}⁻¹), respectively:
In a currently preferred setting, Dealers 1 and 2 operate a pseudo random number generator in sync so that they are able to generate vector A without any message exchange.
In another setting, a trusted 3^{rd} party computes vector A and sends it to Dealers 1 and 2 through a secure communication channel
In another setting, Dealers 1 and 2 generate vector A using other cryptographic techniques, including SMPC and homomorphic encryption.
In another setting, a dealer (or a 3^{rd} party) generates vector A inside of a trusted execution environment or secure enclave and sends the vector to the other dealer (or to both dealers) in encrypted form so that only they can decrypt it using their private key.
In another setting, there is no vector A (or equivalently, A=(1, . . . , 1)).
In another setting once A=(A₀, A₁, . . . , A_{N-1}) is computed or obtained by a dealer, the dealer makes use of a secret sharing mechanism in order to use the network of computing nodes to store this vector. The dealer can then reconstruct this vector at any point in time, whenever it is needed.

2-NMC with Blinding Products requires the number of computing nodes to be equal to the dimension N of the two secret vectors in the inner product. Alternatively, this limitation is removed by increasing the dimension of the secret vectors to M, where M>N, as follows:

$$x = ( {x}_{0} , {x}_{1} , … , {x}_{N - 1} , {x}_{N} , … , {X}_{M - 1} )$$

$$y = ( {y}_{0} , {y}_{1} , … , {y}_{N - 1} , {y}_{N} , … , {y}_{M - 1} )$$

$$such that$$

$${\sum }_{i = N}^{M - 1} {x}_{i} \cdot {y}_{i} = 0$$

This allows for M computing nodes to evaluate the inner product function of two secret vectors of dimension N, where M≥N.

Optionally, a dealer keeps a share of every component of their secret vector so that even if all computing nodes colluded they would not be able to reconstruct the dealer's secret vector.

In another embodiment, dealers 1 and 2 send the same i-th share U_{i,j} and V_{i,j}, respectively to more than one node to achieve fault tolerance. This way, if a node holding shares U_{i,j} and V_{i,j} goes down, there will be other nodes with the same shares.

### Clauses Defining Inventions and Preferred Features Disclosed Herein:

1. A computer-implemented method of performing a multi-party computation by a network of data processors, said data processors comprising first and second dealer nodes, a plurality of M computing nodes, and at least one result node, the method comprising:
(a) providing the first dealer node with a random vector A having components (A₀, A₁, . . . , A_{M-1}) all of which are non-zero;
(b) providing the second dealer node with an inverse vector A⁻¹ having components (A₀⁻¹, A₁⁻¹, . . . , A_{M-1}⁻¹), such that for each i∈{0, . . . , M−1}, the product Aᵢ·Aᵢ⁻¹=1;
(c) the first dealer node computing a first transformed vector X=(X₀, X₁, . . . , X_{M-1}) of a first private input vector x=(x₀, x₁, . . . , x_{M-1}), according to a discrete linear transform for which Parseval's theorem holds;
(d) the first dealer node computing a first blinded vector U=(U₀, U₁, . . . , U_{M-1}) as U=A∘X where the operator ∘ represents the Hadamard product;
(e) the second dealer node computing a second transformed vector Y=(Y₀, Y₁, . . . , Y_{M-1}) of a second private input vector y=(y₀, y₁, . . . , y_{M-1}), according to said discrete linear transform;
(f) the second dealer node computing a second blinded vector V=(V₀, V₁, . . . , V_{M-1}) as V=A⁻¹∘Y where the operator ∘ represents the Hadamard product;
(g) the first dealer sending the i-th component Uᵢ of the first blinded vector U to the i-th computing node for each i∈{0, . . . , M−1};
(h) the second dealer sending the i-th component Vᵢ of the second blinded vector V to the i-th computing node for each i∈{0, . . . , M−1};
(i) for each j∈{0, . . . , (M−1)}, the j-th computing node:
   calculating from its received components Uⱼ and Vⱼ a result share

$${R}_{j} = \frac{1}{M} {U}_{j} \cdot {V}_{j} ,$$

and
sending the result share Rⱼ to one or more of the one or more result nodes;
(j) said one or more result nodes calculating, from the M received result shares Rⱼ for j∈{0, . . . , M−1}, the inner product of the first and second private input vectors x, y as:

$$< x , y > = {\sum }_{j = 0}^{M - 1} {R}_{j}$$

2. A method according to clause 1, wherein the first and second dealer nodes generate the first and second private input vectors x and y of dimension M, respectively, as expansions of original unexpanded private input vectors x_{orig} and y_{orig} of dimension N, respectively, where N<M, and where:

$${x}_{orig} = ( {x}_{0} , {x}_{1} , … , {x}_{N - 1} )$$

$${y}_{orig} = ( {y}_{0} , {y}_{1} , … , {y}_{N - 1} )$$

$$x = ( {x}_{0} , {x}_{1} , … , {x}_{N - 1} , {x}_{N} , … , {x}_{M - 1} )$$

$$y = ( {y}_{0} , {y}_{1} , … , {y}_{N - 1} , {y}_{N} , … , {y}_{M - 1} )$$

and where the components x_{N}, . . . , X_{M-1} and y_{N}, . . . , y_{M-1} are chosen such that:

$${\sum }_{i = N}^{M - 1} {x}_{i} \cdot {y}_{i} = 0$$

3. A method according to clause 1 or 2, wherein the steps of providing the first and second dealers with the random vectors A and A⁻¹ comprise both dealers operating a pseudo-random number generator in sync to generate the components of vector A, and the second dealer node calculating A⁻¹ from the vector A.

4. A method according to clause 1 or 2, wherein the steps of providing the first and second dealers with the random vectors A and A⁻¹ comprise a trusted third party node communicating vector A to the first dealer node and either vector A or vector A⁻¹ to the second dealer node.

5. A method according to clause 1 or 2, wherein the steps of providing the first and second dealers with the random vectors A and A⁻¹ comprise communicating either vector A or vector A⁻¹ cryptographically to at least one of the first and second dealer nodes.

6. A method according to any preceding clause wherein the vector A is {1, 1, . . . , 1}.

7. A computer-implemented method of performing a multi-party computation by a network of data processors, said data processors comprising first and second dealer nodes, a plurality of M computing nodes, and at least one result node, the method comprising:
(a) for each i∈{0, . . . , N−1} where N is the number of components of a first private input vector x=(x₀, x₁, . . . , x_{N-1}) known to the first dealer node and of a second private input vector y=(y₀, y₁, . . . , y_{M-1}) known to the second dealer node, providing the first dealer node with a transformed vector Uᵢ=(U_{i,0}, . . . , U_{i,M-1}) with components U_{i,j}, j∈{0, . . . , (M−1)} which is a transform of a random vector uᵢ=(u_{i,0}, u_{i,1}, . . . , u_{i,M-1}) according to a discrete linear transform for which Parseval's theorem holds;
(b) for each i∈{0, . . . , N−1}, providing the second dealer node with a transformed vector Vᵢ=(V_{i,0}, . . . , V_{i,M-1}) with components V_{i,j}, j∈{0, . . . , (M−1)} which is a transform of a random vector vᵢ=(v_{i,0}, v_{i,1}, . . . , v_{i,M-1}) according to said discrete linear transform, wherein uᵢ and vᵢ satisfy the condition:

$${\sum }_{i = 0}^{N - 1} {\sum }_{j = 1}^{M - 1} {u}_{i , j} \cdot {v}_{i , j} = 0$$

(c) for each j∈{0, . . . , (M−1)}, providing the j-th computing node with each of the components U_{i,j} and V_{i,j} for i∈{0, . . . , N−1};
(d) for each i∈{0, . . . , N−1}, the first dealer node computing a scalar aᵢ=xᵢ−u_{i,0}, and the second dealer node computing a scalar bᵢ=yᵢ−v_{i,0};
(e) the first dealer sending to all computing nodes all of the scalars {a₀, . . . , a_{N-1}};
(f) the second dealer sending to all computing nodes all of the scalars {b₀, . . . , b_{N-1}};
(g) for each j∈{0, . . . , (M−1)}, the j-th computing node computing for each i∈{0, . . . , N−1} the transforms Aᵢ=(A_{i,0}, . . . , A_{i,M-1}) and Bᵢ=(B_{i,0}, . . . , B_{i,M-1}), wherein Aᵢ is the transform according to said discrete linear transform of a vector (aᵢ, 0, . . . , 0) and wherein Bᵢ is the transform according to said discrete linear transform of a vector (bᵢ, 0, . . . , 0);
(h) for each j∈{0, . . . , (M−1)}, the j-th computing node computing for each i∈{0, . . . , N−1}: C_{i,j}=U_{i,j}+A_{i,j} and D_{i,j}=V_{i,j}+B_{i,j};
(i) or each j∈{0, . . . , (M−1)}, the j-th computing node computing a result share:

$${R}_{j} = \frac{1}{M} {\sum }_{i = 0}^{N - 1} {C}_{i , j} \cdot {D}_{i , j}$$

(j) for each j∈{0, . . . , (M−1)}, the j-th computing node sending the result share to one or more of the one or more result nodes;
(k) said one or more result nodes calculating, from the M received result shares Rⱼ for j∈{0, . . . , M−1}, the inner product of the first and second private input vectors x, y as:

$$< x , y > = {\sum }_{j = 0}^{M - 1} {R}_{j}$$

8. A computer-implemented method according to clause 7, wherein each dealer node independently generates random values u_{i,0}, v_{i,0}, i∈{0, . . . , N−1}, respectively, and completes the N vectors

$${u}_{i} = ( {u}_{i , 0} , {u}_{i , 1} , … , {u}_{i , M - 1} )$$

$${v}_{i} = ( {v}_{i , 0} , {v}_{i , 1} , … , {v}_{i , M - 1} )$$

such that the condition Σᵢ₌₀^{N-1}Σⱼ₌₁^{M-1}u_{i,j}·v_{i,j}=0 holds.

9. A computer-implemented method according to clause 8, wherein the first dealer node and second dealer node are programmed with rules to ensure that for any corresponding pair of vector components u_{i,j} and v_{i,j} and j>0, one of the pair is zero.

10. A computer-implemented method according to clause 8, wherein the first dealer node and second dealer node are programmed with rules to ensure that for each i∈{0, . . . , N−1}, a first subset of indices j∈{1, . . . , (M−1)} are allocated for the first dealer node to set the vector components u_{i,j} equal to one, and a second subset of indices j∈{1, . . . , (M−1)} are allocated for the second dealer node to set the vector components v_{i,j} equal to one, with each dealer node setting the remaining components of its respective vector uᵢ or vᵢ to sum to zero.

11. A computer-implemented method according to clause 8, wherein the first and second dealer nodes run a pseudo-random generator in sync with one another, and wherein the values of the components u_{i,j} and v_{i,j} are identical and wherein at least one vector component is computed by at least one dealer node to ensure that

$${\sum }_{i = 0}^{N - 1} {\sum }_{j = 1}^{M - 1} {u}_{i , j} \cdot {v}_{i , j} = 0$$

12. A computer-implemented method according to clause 7, wherein the vectors uᵢ and vᵢ are collaboratively generated such that each pair of opposed components {u_{i,j}, v_{i,j}} for j∈{1, . . . , M−1} has one of the pair of components set to zero.

13. A computer-implemented method according to clause 12, wherein the vectors uᵢ and vᵢ are of the form:

$${u}_{i} = ( {u}_{i , 0} , 0 , … , 0 , {u}_{i , ( M - 1 ) / 2 + 1} , … , {u}_{i , M - 1} ) , \\ {v}_{i} = ( {v}_{i , 0} , {v}_{i , 1} , … , {v}_{i , ( M - 1 ) / 2} , 0 , … , 0 \} ,$$

where u_{i,0}, u_{i,(M-1)/2+1}, . . . , u_{i,M-1} and v_{i,0}, v_{i,1}, . . . , v_{i,(M-1)/2} are random or pseudo-random.

14. A computer-implemented method according to clause 12 or 13, wherein the M computing nodes collaboratively compute the vectors uᵢ and vᵢ.

15. A computer-implemented method according to clause 14, wherein the M computing nodes further collaboratively compute the transforms Uᵢ and Vᵢ.

16. A computer-implemented method according to clause 15, wherein for each j∈{0, . . . , (M−1)}, the j-th computing node for each i∈{0, . . . , N−1}:
(i) generating a random share [u_{i,q}]ⱼ of component u_{i,q}, for q∈{0, (M−1)/2+1, . . . , M−1};
(ii) evaluating a public polynomial p(α), which satisfies p(0)=0, at α=αⱼ to obtain a share [0]ⱼ of every zero component of vector uᵢ;
(iii) generating a random share [v_{i,q}]ⱼ of component v_{i,q}, for q∈{0, 1, . . . , (M−1)/2;
(iv) evaluating said public polynomial p(α) at α=αⱼ to obtain a share [0]ⱼ of every zero component of vector vᵢ;
(v) locally computing a share of each component of the transformed vectors Uᵢ=(U_{i,0}, U_{i,1}, . . . , U_{i,M-1}), Vᵢ=(V_{i,0}, V_{i,1}, . . . , V_{i,M-1}) as follows:

$$\begin{matrix}{[ {U}_{i , k} ]}_{j} = {\sum }_{q = 0}^{M - 1} {{λ}_{k , q} [ {u}_{i , q} ]}_{j} \\ {[ {V}_{i , k} ]}_{j} = {\sum }_{q = 0}^{M - 1} {{λ}_{k , q} [ {v}_{i , q} ]}_{j}\end{matrix} i ∈ \{ 0 , … , N - 1 \} , k ∈ \{ 0 , … , M - 1 \}$$

where λ_{k,q} is an element of the transform matrix indexed as

$$( \begin{matrix}{λ}_{0 , 0} & … & {λ}_{0 , M - 1} \\ ⋮ & ⋱ & ⋮ \\ {λ}_{M - 1 , 0} & … & {λ}_{M - 1 , M - 1}\end{matrix} )$$

which acts on a vector cᵢ=(xᵢ, u_{i,1}, . . . , u_{i,M-1}) to generate its transformed vector Cᵢ=(C_{i,0}, . . . , C_{i,M-1}), i∈{0, . . . , N−1}:

$$( \begin{matrix}{C}_{i , 0} \\ {C}_{i , 1} \\ ⋮ \\ {C}_{i , M - 1}\end{matrix} ) = ( \begin{matrix}1 & 1 & … & 1 \\ 1 & α & … & {α}^{( M - 1 )} \\ ⋮ & ⋮ & ⋱ & ⋮ \\ 1 & {α}^{( M - 1 )} & … & {α}^{{( M - 1 )}^{2}}\end{matrix} ) ( \begin{matrix}{x}_{i} \\ {u}_{i , 1} \\ ⋮ \\ {u}_{i , M - 1}\end{matrix} )$$

(vi) sending its shares [U_{i,k}]ⱼ, [V_{i,k}]ⱼ of the k-th component from the transformed vectors Uᵢ, Vᵢ to the k-th computing node, for k∈{0, . . . , M−1}; and
(vii) sending its shares [U_{i,k}]₀, . . . , [U_{i,k}]_{M-1} to the first dealer, and its shares [V_{i,k}]₀, . . . , [V_{i,k}]_{M-1} to the second dealer;
whereby the first and second dealers are provided with the shares necessary to reconstruct the transformed vectors Uᵢ=(U_{i,0}, U_{i,1}, . . . , U_{i,M-1}), Vᵢ=(V_{i,0}, V_{i,1}, . . . , V_{i,M-1}), i∈{0, . . . , N−1}, respectively; and
whereby the j-th computing node ends up with all the shares necessary to reconstruct U_{i,j} and V_{i,j}, for i∈{0, . . . , N−1} without learning either uᵢ=(u_{i,0}, u_{i,1}, . . . , u_{i,M-1}) or vᵢ=(v_{i,0}, v_{i,1}, . . . , v_{i,M-1}).

17. A computer-implemented method according to clause 7, wherein the vectors uᵢ and vᵢ are collaboratively generated such that each component of pair of uᵢ and vᵢ is a random or pseudo-random number, other than one component of uᵢ or vᵢ which is chosen so that the condition: Σᵢ₌₀^{N-1}Σⱼ₌₁^{M-1}u_{i,j}·v_{i,j}=0 holds.

18. A computer-implemented method according to clause 7, wherein the vectors uᵢ and vᵢ are generated inside a trusted execution environment and communicated in encrypted form to the first and second dealer nodes respectively.

19. A computer-implemented method of performing a multi-party computation by a network of data processors, said data processors comprising first and second dealer nodes, a plurality of M computing nodes, and at least one result node, the method comprising:
(a) the first dealer node constructing a first set of N M-dimensional vectors
   {u₀, u₁ . . . , u_{N-1}} from a first private input vector x=(x₀, x₁, . . . , x_{N-1}) where:

$${u}_{0} = ( {x}_{0} , {u}_{0 , 1} , … , {u}_{0 , M - 1} ) , \\ {u}_{1} = ( {x}_{1} , {u}_{1 , 1} , … , {u}_{1 , M - 1} ) , … , \\ {u}_{N - 1} = ( {x}_{N - 1} , {u}_{N - 1 , 1} , … , {u}_{N - 1 , M - 1} ) ,$$

(b) the second dealer node constructing a second set of N M-dimensional vectors
   {v₀, v₁ . . . , v_{N-1}} from a second private input vector y=(y₀, y₁, . . . , y_{N-1}) where:

$${v}_{0} = ( {y}_{0} , {v}_{0 , 1} , … , {v}_{0 , M - 1} ) , \\ {v}_{1} = ( {y}_{1} , {v}_{1 , 1} , … , {v}_{1 , M - 1} ) , … , \\ {v}_{N - 1} = ( {y}_{N - 1} , {v}_{N - 1 , 1} , … , {v}_{N - 1 , M - 1} ) ,$$

wherein the vector components u_{i,j} and v_{i,j} satisfy the condition:

$${\sum }_{i = 0}^{N - 1} {\sum }_{j = 1}^{M - 1} {u}_{i , j} \cdot {v}_{i , j} = 0$$

(c) the first dealer node computing a respective transformed vector Uᵢ=(U_{i,0}, U_{i,1}, . . . , U_{i,M-1}) of each M-dimensional vector uᵢ of said first set, according to a discrete linear transform for which Parseval's theorem holds;
(d) the second dealer node computing a respective transformed vector Vᵢ=(V_{i,0}, V_{i,1}, . . . , V_{i,M-1}) of each M-dimensional vector vᵢ of said second set, according to said discrete linear transform;
(e) for each transformed vector Uᵢ for i∈{0, . . . , N−1}, the first dealer sending the j-th component U_{i,j} to the j-th computing node for j∈{0, . . . , M−1};
(f) for each transformed vector Vᵢ for i∈{0, . . . , N−1}, the second dealer sending the j-th component V_{i,j} to the j-th computing node for j∈{0, . . . , M−1};
(g) for each j∈{0, . . . , (M−1)}, the j-th computing node computing from the received components U_{i,j} and V_{i,j} for i∈{0, . . . , N−1} a result share Rⱼ where

$${R}_{j} = \frac{1}{M} {\sum }_{i = 0}^{N - 1} {U}_{i , j} \cdot {V}_{i , j}$$

(k) for each j∈{0, . . . , (M−1)}, the j-th computing node sending the result share Rⱼ to one or more of the one or more result nodes;
(l) said one or more result nodes calculating, from the M received result shares Rⱼ for j∈{0, . . . , M−1}, the inner product of the first and second private input vectors x, y as:

$$〈 x , y 〉 = {\sum }_{j = 0}^{M - 1} {R}_{j}$$

20. A computer-implemented method according to clause 19, wherein the first dealer node and second dealer node are programmed with rules to ensure that for any corresponding pair of vector components u_{i,j} and v_{i,j} one of the pair is zero.

21. A computer-implemented method according to clause 20, wherein said rules ensure that for each i∈{0, . . . , N−1}, the indices j∈{0, . . . , (M−1)} are allocated between the first and second dealer nodes, with the first dealer node being allocated a first subset of indices for which the components u_{i,j} are zero, and the second dealer node being allocated a second subset of indices for which the components v_{i,j} are zero, and wherein the union of the first and second subsets is the set {0, . . . , (M−1)}.

22. A computer-implemented method according to clause 20 or 21, wherein the first and second dealer nodes are programmed to set all components whose indices are not part of the first subset or second subset respectively allocated to that node to a random value.

23. A computer-implemented method according to clause 19, wherein the first dealer node and second dealer node are programmed with rules to ensure that for each i∈{0, . . . , N−1}, a first subset of indices j∈{0, . . . , (M−1)} are allocated for the first dealer node to set the vector components u_{i,j} equal to one, and a second subset of indices j∈{0, . . . , (M−1)} are allocated for the second dealer node to set the vector components v_{i,j} equal to one, with each dealer node setting the remaining components of its respective vector uᵢ or vᵢ to sum to zero.

24. A computer-implemented method according to clause 23, wherein each dealer node setting the remaining components of its respective vector uᵢ or vᵢ to sum to zero comprises setting a portion of the remaining components to a random value and the remainder of the remaining components to a value or values that ensure the aggregate remaining components sum to zero.

25. A computer-implemented method according to clause 19, wherein the first and second dealer nodes runs a pseudo-random generator in sync with one another, and wherein the values of the components u_{i,j} and v_{i,j} are identical and wherein at least one vector component is computed by at least one dealer node to ensure that

$${\sum }_{i = 0}^{N - 1} {\sum }_{j = 1}^{M - 1} {u}_{i , j} \cdot {v}_{i , j} = 0$$

26. A method according to any preceding clause, wherein the private input vectors have integer components and arithmetical operations are performed modulo a prime number p.

27. A method according to any preceding clause, wherein the discrete linear transform for which Parseval's theorem holds is selected from:
the Number Theoretic Transform (NTT);
the Fermat Number Transform (FNT);
the Mersenne Number Transform (MNT);
the Discrete Fourier Transform;
the Z-Transform;
the Discrete Hartley Transform;
the Discrete Wavelet Transform with arbitrary orthogonal wavelet bases, such as Haar, Daubechies, Simlets, Coiflets, Meyer, Morlet and Gaussian wavelet families.

28. A method according to any preceding clause, wherein the private input vectors have real or complex number components.

1. A method of performing a multi-party computation by a network of data processors, said data processors comprising first and second dealer nodes, a plurality of M computing nodes, and at least one result node, the method comprising:
(a) providing the first dealer node with a random vector A having components (A₀, A₁, . . . , A_{M-1}) all of which are non-zero;
(b) providing the second dealer node with an inverse vector A⁻¹ having components (A₀⁻¹, A₁⁻¹, . . . , A_{M-1}⁻¹), such that for each i∈{0, . . . , M−1}, the product Aᵢ·Aᵢ⁻¹=1;
(c) the first dealer node computing a first transformed vector X=(X₀, X₁, . . . , X_{M-1}) of a first private input vector x=(x₀, x₁, . . . , x_{M-1}), according to a discrete linear transform for which Parseval's theorem holds;
(d) the first dealer node computing a first blinded vector U=(U₀, U₁, . . . , U_{M-1}) as U=A∘X where the operator ∘ represents the Hadamard product;
(e) the second dealer node computing a second transformed vector Y=(Y₀, Y₁, . . . , Y_{M-1}) of a second private input vector y=(y₀, y₁, . . . , y_{M-1}), according to said discrete linear transform;
(f) the second dealer node computing a second blinded vector V=(V₀, V₁, . . . , V_{M-1}) as V=A⁻¹∘Y where the operator ∘ represents the Hadamard product;
(g) the first dealer sending the i-th component Uᵢ of the first blinded vector U to the i-th computing node for each i∈{0, . . . , M−1};
(h) the second dealer sending the i-th component Vᵢ of the second blinded vector V to the i-th computing node for each i∈{0, . . . , M−1};
(i) for each j∈{0, . . . , (M−1)}, the j-th computing node:
calculating from its received components Uⱼ and Vⱼ a result share
$${R}_{j} = \frac{1}{M} {U}_{j} \cdot {V}_{j} ,$$
and
sending the result share Rⱼ to one or more of the one or more result nodes;
(j) said one or more result nodes calculating, from the M received result shares Rⱼ for j∈{0, . . . , M−1}, the inner product of the first and second private input vectors x, y as:
$$〈 x , y 〉 = {\sum }_{j = 0}^{M - 1} {R}_{j}$$

2. The method according to claim 1, wherein the first and second dealer nodes generate the first and second private input vectors x and y of dimension M, respectively, as expansions of original unexpanded private input vectors x_{orig} and y_{orig} of dimension N, respectively, where N<M, and where:
$${x}_{orig} = ( {x}_{0} , {x}_{1} , … , {x}_{N - 1} ) \\ {y}_{orig} = ( {y}_{0} , {y}_{1} , … , {y}_{N - 1} ) \\ x = ( {x}_{0} , {x}_{1} , … , {x}_{N - 1} , {x}_{N} , … , {x}_{M - 1} ) \\ y = ( {y}_{0} , {y}_{1} , … , {y}_{N - 1} , {y}_{N} , … , {y}_{M - 1} )$$
and where the components x_{N}, . . . , x_{M-1} and y_{N}, . . . , y_{M-1} are chosen such that:
$${\sum }_{i = N}^{M - 1} {x}_{i} \cdot {y}_{i} = 0$$

3. The method according to claim 1, wherein the steps of providing the first and second dealers with the random vectors A and A⁻¹ comprise both dealers operating a pseudo-random number generator in sync to generate the components of vector A, and the second dealer node calculating A⁻¹ from the vector A.

4. The method according to claim 1, wherein the steps of providing the first and second dealers with the random vectors A and A⁻¹ comprise a trusted third party node communicating vector A to the first dealer node and either vector A or vector A⁻¹ to the second dealer node.

5. The method according to claim 1, wherein the steps of providing the first and second dealers with the random vectors A and A⁻¹ comprise communicating either vector A or vector A⁻¹ cryptographically to at least one of the first and second dealer nodes.

6. The method according to claim 1, wherein the vector A is {1, 1, . . . , 1}.

7. The method according to claim 1, wherein the private input vectors have integer components and arithmetical operations are performed modulo a prime number p.

8. The method according to claim 1, wherein the discrete linear transform for which Parseval's theorem holds is selected from:
the Number Theoretic Transform (NTT);
the Fermat Number Transform (FNT);
the Mersenne Number Transform (MNT);
the Discrete Fourier Transform;
the Z-Transform;
the Discrete Hartley Transform;
the Discrete Wavelet Transform with arbitrary orthogonal wavelet bases, such as Haar, Daubechies, Simlets, Coiflets, Meyer, Morlet and Gaussian wavelet families.

9. The method according to claim 1, wherein the discrete linear transform is not the null function.

10. The method according to claim 1, wherein the discrete linear transform is not the identity function.

11. The method according to claim 1, wherein the private input vectors have real or complex number components.
